(19) United States
(12) Patent Application Publication
(10) Pub. No.: US 2023/0124233 A1
(43) Pub. Date: Apr. 20, 2023

(54) METHOD AND APPARATUS FOR PERFORMING DCI BASED SIDELINK COMMUNICATION IN NR V2X

(71) Applicant: LG ELECTRONICS INC., Seoul (KR)

(72) Inventors: Seungmin LEE, Seoul (KR); Hanbyul SEO, Seoul (KR)

(73) Assignee: LG ELECTRONICS INC., Seoul (KR)

(21) Appl. No.: 17/778,763

(22) PCT Filed: Nov. 20, 2020
(86) PCT No.: PCT/KR2020/016501

§ 371 Date: Dec. 29, 2022

Related U.S. Application Data
(60) Provisional application No. 62/938,290, filed on Nov. 20, 2019.
(60) Provisional application No. 62/938,910, filed on Nov. 21, 2019.

(51) Int. Cl. H04W 24/08; H04W 72/121; H04W 72/25

(52) U.S. Cl. CPC H04W 24/08; H04W 72/121; H04W 72/25

(57) ABSTRACT

According to one embodiment of the present disclosure, provided is a method by which a first device performs sidelink communication. The method comprises the steps of: receiving a first DCI including information on a resource for LTE sidelink communication of the first device through a PDCCH from an NR base station; transmitting an SCI to a second device through a PSCCH on the basis of the resource; and transmitting data to the second device through a PSSCH related to the PSCCH, wherein the size of the first DCI can be adjusted from the size of a second DCI to the size of the first DCI, on the basis of the size of the first DCI that is obtained by the NR base station through at least one second DCI different from the first DCI.

### TECHNICAL FIELD

This disclosure relates to a wireless communication system.

### BACKGROUND

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

FIG. 1 is a drawing for describing V2X communication based on NR, compared to V2X communication based on RAT used before NR. The embodiment of FIG. 1 may be combined with various embodiments of the present disclosure.

Regarding V2X communication, a scheme of providing a safety service, based on a V2X message such as Basic Safety Message (BSM), Cooperative Awareness Message (CAM), and Decentralized Environmental Notification Message (DENM) is focused in the discussion on the RAT used before the NR. The V2X message may include position information, dynamic information, attribute information, or the like. For example, a UE may transmit a periodic message type CAM and/or an event triggered message type DENM to another UE.

For example, the CAM may include dynamic state information of the vehicle such as direction and speed, static data of the vehicle such as a size, and basic vehicle information such as an exterior illumination state, route details, or the like. For example, the UE may broadcast the CAM, and latency of the CAM may be less than 100 ms. For example, the UE may generate the DENM and transmit it to another UE in an unexpected situation such as a vehicle breakdown, accident, or the like. For example, all vehicles within a transmission range of the UE may receive the CAM and/or the DENM. In this case, the DENM may have a higher priority than the CAM.

Thereafter, regarding V2X communication, various V2X scenarios are proposed in NR. For example, the various V2X scenarios may include vehicle platooning, advanced driving, extended sensors, remote driving, or the like.

For example, based on the vehicle platooning, vehicles may move together by dynamically forming a group. For example, in order to perform platoon operations based on the vehicle platooning, the vehicles belonging to the group may receive periodic data from a leading vehicle. For example, the vehicles belonging to the group may decrease or increase an interval between the vehicles by using the periodic data.

For example, based on the advanced driving, the vehicle may be semi-automated or fully automated. For example, each vehicle may adjust trajectories or maneuvers, based on data obtained from a local sensor of a proximity vehicle and/or a proximity logical entity. In addition, for example, each vehicle may share driving intention with proximity vehicles.

For example, based on the extended sensors, raw data, processed data, or live video data obtained through the local sensors may be exchanged between a vehicle, a logical entity, a UE of pedestrians, and/or a V2X application server. Therefore, for example, the vehicle may recognize a more improved environment than an environment in which a self-sensor is used for detection.

For example, based on the remote driving, for a person who cannot drive or a remote vehicle in a dangerous environment, a remote driver or a V2X application may operate or control the remote vehicle. For example, if a route is predictable such as public transportation, cloud computing based driving may be used for the operation or control of the remote vehicle. In addition, for example, an access for a cloud-based back-end service platform may be considered for the remote driving.

Meanwhile, a scheme of specifying service requirements for various V2X scenarios such as vehicle platooning, advanced driving, extended sensors, remote driving, or the like is discussed in NR-based V2X communication.

### SUMMARY

The present disclosure provides a method for communication between devices (or UEs) based on V2X communication, and device(s) (or UE(s)) performing the method.

The present disclosure provides a method for performing sidelink communication based on downlink control information (DCI) in NR V2X and device(s) (or UE(s)) performing the method.

Based on an embodiment of the present disclosure, provided is a method for performing sidelink communication by a first device. The method may comprise: receiving, from a new radio (NR) base station through a physical downlink control channel (PDCCH), first downlink control information (DCI) including information regarding a resource for long-term evolution (LTE) sidelink communication of the first device; transmitting, to a second device through a physical sidelink control channel (PSCCH), sidelink control information (SCI) based on the resource; and transmitting data to the second device through a physical sidelink shared channel (PSSCH) related to the PSCCH, wherein, based on a first DCI size obtained based on at least one second DCI different from the first DCI, a size of the first DCI is aligned by the NR base station from a second DCI size to the first DCI size.

Based on an embodiment of the present disclosure, provided is a first device adapted to perform sidelink communication. The first device may comprise: at least one memory storing instructions; at least one transceiver; and at least one processor connected to the at least one memory and the at least one transceiver. The at least one processor may execute the instructions to: control the at least one transceiver to receive, from a new radio (NR) base station through a physical downlink control channel (PDCCH), first downlink control information (DCI) including information regarding a resource for long-term evolution (LTE) sidelink communication of the first device; control the at least one transceiver to transmit, to a second device through a physical sidelink control channel (PSCCH), sidelink control information (SCI) based on the resource; and control the at least one transceiver to transmit data to the second device through a physical sidelink shared channel (PSSCH) related to the PSCCH, wherein, based on a first DCI size obtained based on at least one second DCI different from the first DCI, a size of the first DCI is aligned by the NR base station from a second DCI size to the first DCI size.

Based on an embodiment of the present disclosure, provided is an apparatus (or a chip(set)) adapted to control a first user equipment (UE). The apparatus may comprise: at least one processor; and at least one memory connected to the at least one processor and storing instructions. The at least one processor may execute the instructions to: receive, from a new radio (NR) base station through a physical downlink control channel (PDCCH), first downlink control information (DCI) including information regarding a resource for long-term evolution (LTE) sidelink communication of the first UE; transmit, to a second UE through a physical sidelink control channel (PSCCH), sidelink control information (SCI) based on the resource; and transmit data to the second UE through a physical sidelink shared channel (PSSCH) related to the PSCCH, wherein, based on a first DCI size obtained based on at least one second DCI different from the first DCI, a size of the first DCI is aligned by the NR base station from a second DCI size to the first DCI size.

Based on an embodiment of the present disclosure, provided is a non-transitory computer-readable storage medium storing instructions (or commands). The non-transitory computer-readable storage medium, when the instructions are executed, causes a first device to: receive, from a new radio (NR) base station through a physical downlink control channel (PDCCH), first downlink control information (DCI) including information regarding a resource for long-term evolution (LTE) sidelink communication of the first device; transmit, to a second device through a physical sidelink control channel (PSCCH), sidelink control information (SCI) based on the resource; and transmit data to the second device through a physical sidelink shared channel (PSSCH) related to the PSCCH, wherein, based on a first DCI size obtained based on at least one second DCI different from the first DCI, a size of the first DCI is aligned by the NR base station from a second DCI size to the first DCI size.

Based on an embodiment of the present disclosure, provided is a method for performing wireless communication by an NR base station. The method may comprise: aligning a size of first DCI from a second DCI size to a first DCI size, based on the first DCI size obtained based on at least one second DCI different from the first DCI including information regarding a resource for LTE sidelink communication of a first device; and transmitting the first DCI to the first device through a PDCCH.

Based on an embodiment of the present disclosure, provided is an NR base station adapted to perform wireless communication. The base station may comprise: at least one memory storing instructions; at least one transceiver; and at least one processor connected to the at least one memory and the at least one transceiver. The at least one processor may execute the instructions to: align a size of first DCI from a second DCI size to a first DCI size, based on the first DCI size obtained based on at least one second DCI different from the first DCI including information regarding a resource for LTE sidelink communication of a first device; and control the at least one transceiver to transmit the first DCI to the first device through a PDCCH.

Based on the present disclosure, V2X communication between devices (or UEs) can be efficiently performed.

Based on the present disclosure, even under a situation in which DCI 3_0 (or NR sidelink mode 1 DCI) is not monitored, size fitting can be performed for DCI 3_1 (or cross-RAT DCI) such that a DCI size budget, the number of times of blind decoding, etc. that can be supported by the UE are not exceeded.

### BRIEF DESCRIPTION OF THE DRAWINGS

FIG. 1 is a drawing for describing V2X communication based on NR, compared to V2X communication based on RAT used before NR.

FIG. 2 shows a structure of an NR system, based on an embodiment of the present disclosure.

FIG. 3 shows a functional division between an NG-RAN and a 5GC, based on an embodiment of the present disclosure.

FIGS. 4A and 4B show a radio protocol architecture, based on an embodiment of the present disclosure.

FIG. 5 shows a structure of an NR system, based on an embodiment of the present disclosure.

FIG. 6 shows a structure of a slot of an NR frame, based on an embodiment of the present disclosure.

FIG. 7 shows an example of a BWP, based on an embodiment of the present disclosure.

FIGS. 8A and 8B show a radio protocol architecture for a SL communication, based on an embodiment of the present disclosure.

FIG. 9 shows a UE performing V2X or SL communication, based on an embodiment of the present disclosure.

FIGS. 10A and 10B show a procedure of performing V2X or SL communication by a UE based on a transmission mode, based on an embodiment of the present disclosure.

FIGS. 11A to 11C show three cast types, based on an embodiment of the present disclosure.

FIGS. 12A and 12B show an example of chain-based resource reservation.

FIG. 13 shows an example of block-based resource reservation.

FIG. 14 shows a method for a first device to perform sidelink communication based on DCI received from a NR base station based on an embodiment.

FIG. 15 shows operations of the first device based on an embodiment of the present disclosure.

FIG. 16 shows operations of the NR base station based on an embodiment of the present disclosure.

FIG. 17 shows a communication system 1, based on an embodiment of the present disclosure.

FIG. 18 shows wireless devices, based on an embodiment of the present disclosure.

FIG. 19 shows a signal process circuit for a transmission signal, based on an embodiment of the present disclosure.

FIG. 20 shows another example of a wireless device, based on an embodiment of the present disclosure.

FIG. 21 shows a hand-held device, based on an embodiment of the present disclosure.

FIG. 22 shows a vehicle or an autonomous vehicle, based on an embodiment of the present disclosure.

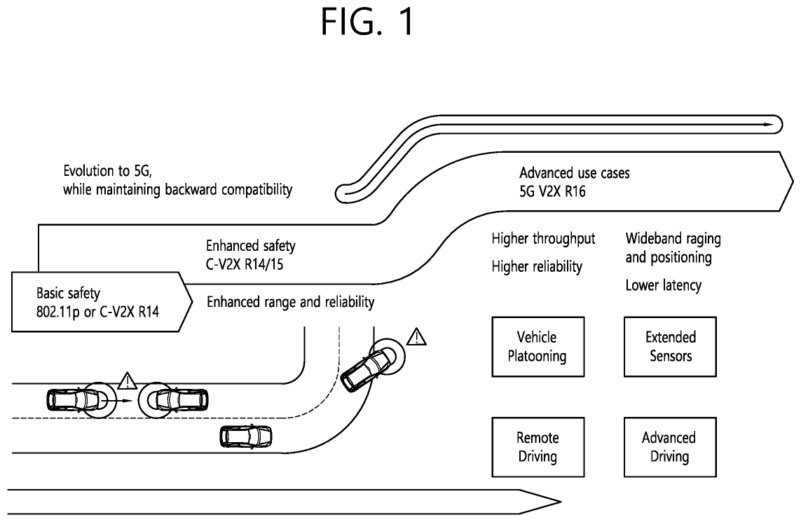

### DETAILED DESCRIPTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

A technical feature described individually in one figure in the present disclosure may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

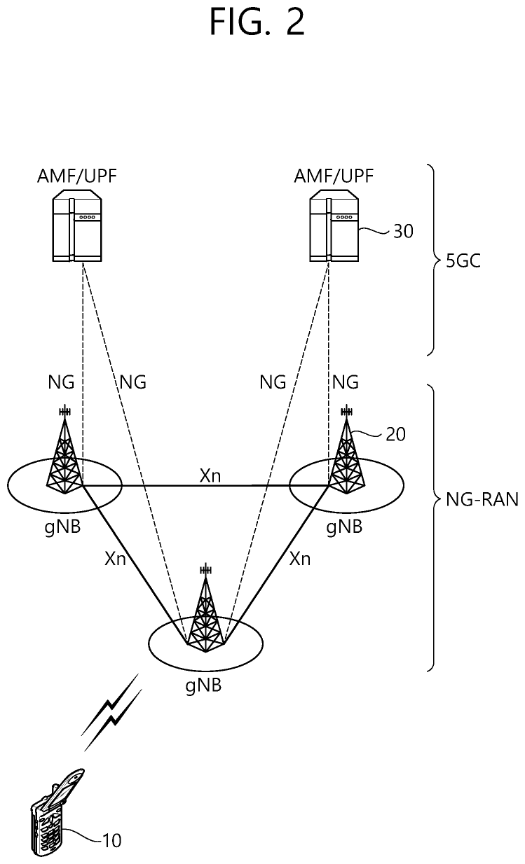

FIG. 2 shows a structure of an NR system, based on an embodiment of the present disclosure. The embodiment of FIG. 2 may be combined with various embodiments of the present disclosure.

Referring to FIG. 2, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 2 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

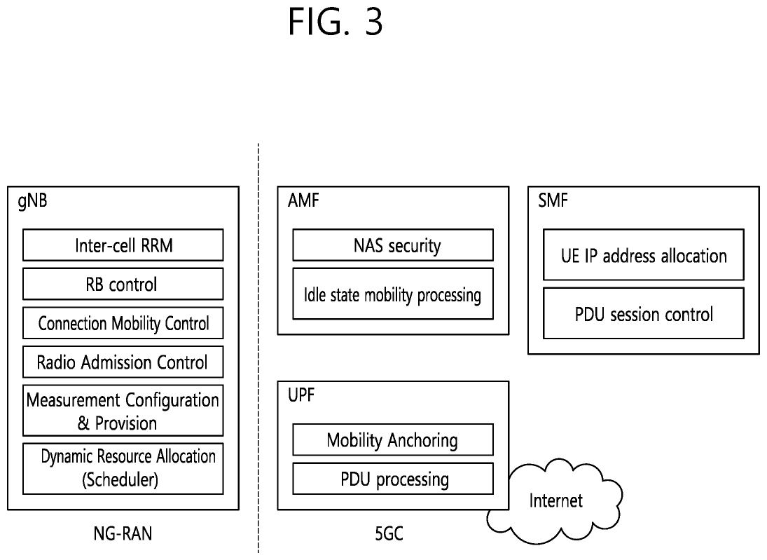

FIG. 3 shows a functional division between an NG-RAN and a 5GC, based on an embodiment of the present disclosure. The embodiment of FIG. 3 may be combined with various embodiments of the present disclosure.

Referring to FIG. 3, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

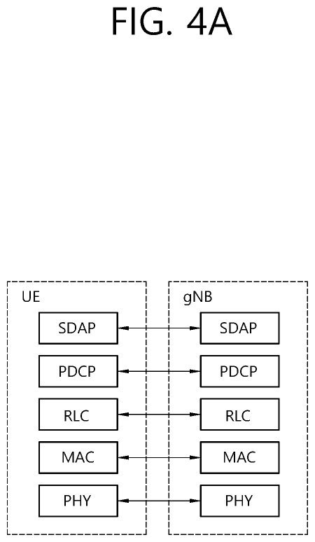

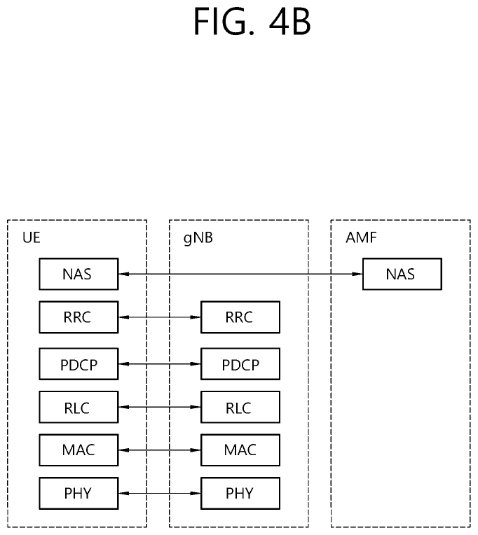

FIGS. 4A and 4B show a radio protocol architecture, based on an embodiment of the present disclosure. The embodiment of FIGS. 4A and 4B may be combined with various embodiments of the present disclosure. Specifically, FIG. 4A shows a radio protocol architecture for a user plane, and FIG. 4B shows a radio protocol architecture for a control plane. The user plane corresponds to a protocol stack for user data transmission, and the control plane corresponds to a protocol stack for control signal transmission.

Referring to FIGS. 4A and 4B, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

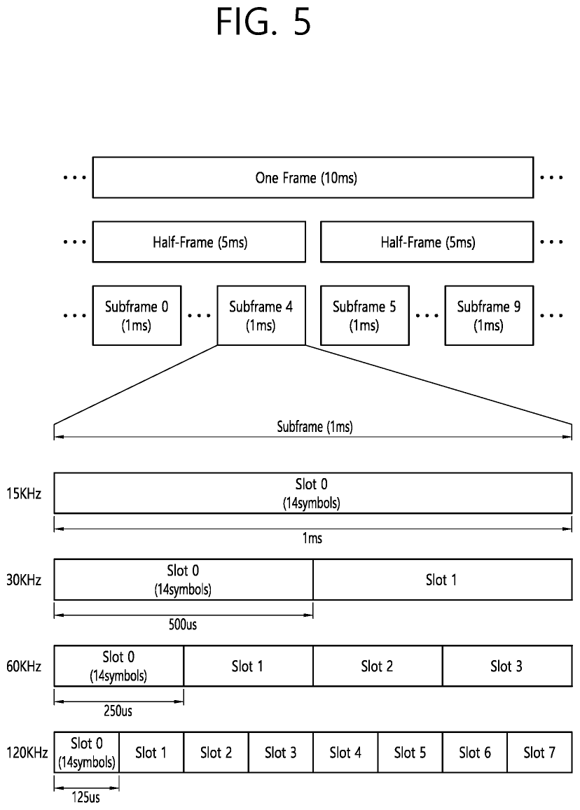

FIG. 5 shows a structure of an NR system, based on an embodiment of the present disclosure. The embodiment of FIG. 5 may be combined with various embodiments of the present disclosure.

Referring to FIG. 5, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined based on subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame,u}ₛₗₒₜ), and a number of slots per subframe (N^{subframe,u}ₛₗₒₜ) based on an SCS configuration (u), in a case where a normal CP is used.

TABLE 1

| | | | |
|---|---|---|---|
| SCS (15*2^{u}) | N^{slot}_{symb} | N^{frame, u}ₛₗₒₜ | N^{subframe, u}ₛₗₒₜ |

| | | | | |
|---|---|---|---|---|
| 15 | KHz (u = 0) | 14 | 10 | 1 |
| 30 | KHz (u = 1) | 14 | 20 | 2 |
| 60 | KHz (u = 2) | 14 | 40 | 4 |
| 120 | KHz (u = 3) | 14 | 80 | 8 |
| 240 | KHz (u = 4) | 14 | 160 | 16 |

Table 2 shows an example of a number of symbols per slot, a number of slots per frame, and a number of slots per subframe based on the SCS, in a case where an extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | Subcarrier | |
|---|---|---|---|
| designation | frequency range | Spacing (SCS) | |
| FR1 | 450 MHz-6000 MHz | 15, 30, 60 | kHz |
| FR2 | 24250 MHz-52600 MHz | 60, 120, 240 | kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | Subcarrier | |
|---|---|---|---|
| designation | frequency range | Spacing (SCS) | |
| FR1 | 410 MHz-7125 MHz | 15, 30, 60 | kHz |
| FR2 | 24250 MHz-52600 MHz | 60, 120, 240 | kHz |

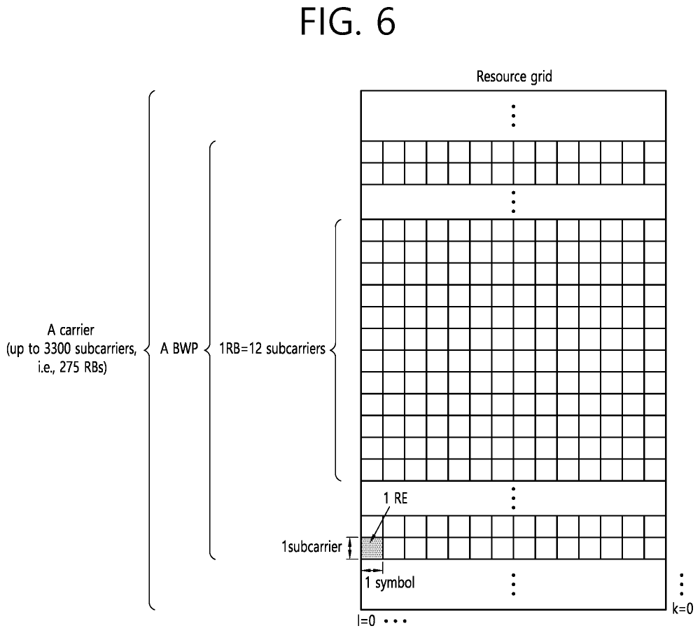

FIG. 6 shows a structure of a slot of an NR frame, based on an embodiment of the present disclosure. The embodiment of FIG. 6 may be combined with various embodiments of the present disclosure.

Referring to FIG. 6, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, physical downlink shared channel (PDSCH), or channel state information-reference signal (CSI-RS) (excluding RRM) outside the active DL BWP. For example, the UE may not trigger a channel state information (CSI) report for the inactive DL BWP. For example, the UE may not transmit physical uplink control channel (PUCCH) or physical uplink shared channel (PUSCH) outside an active UL BWP. For example, in a downlink case, the initial BWP may be given as a consecutive RB set for a remaining minimum system information (RMSI) control resource set (CORESET) (configured by physical broadcast channel (PBCH)). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

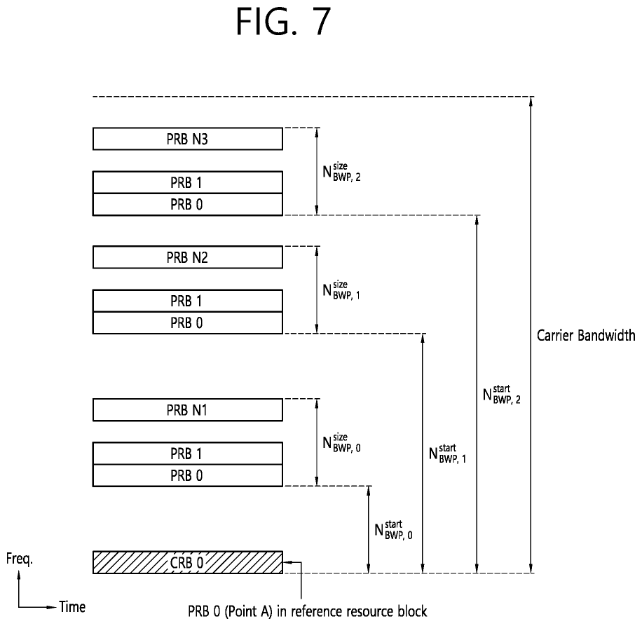

FIG. 7 shows an example of a BWP, based on an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

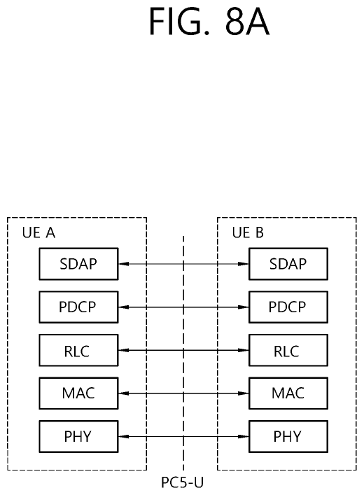

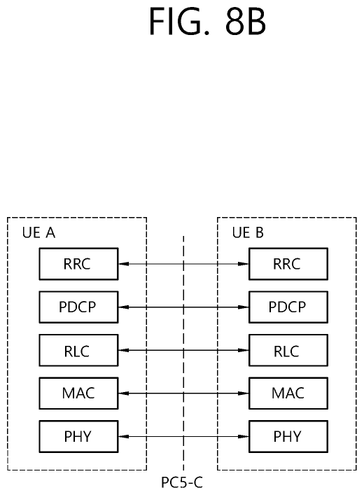

FIGS. 8A and 8B show a radio protocol architecture for a SL communication, based on an embodiment of the present disclosure. The embodiment of FIGS. 8A and 8B may be combined with various embodiments of the present disclosure. More specifically, FIG. 8A shows a user plane protocol stack, and FIG. 8B shows a control plane protocol stack.

Hereinafter, a sidelink synchronization signal (SLSS) and synchronization information will be described.

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

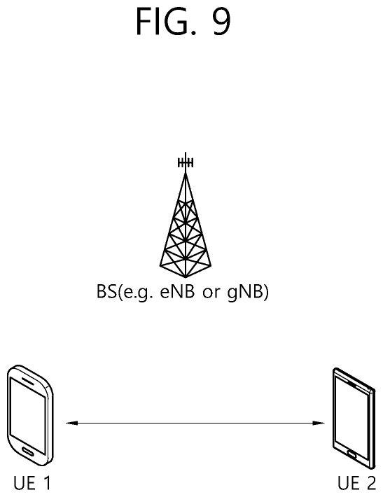

FIG. 9 shows a UE performing V2X or SL communication, based on an embodiment of the present disclosure. The embodiment of FIG. 9 may be combined with various embodiments of the present disclosure.

Referring to FIG. 9, in V2X or SL communication, the term ‘UE’ may generally imply a UE of a user. However, if a network equipment such as a BS transmits/receives a signal according to a communication scheme between UEs, the BS may also be regarded as a sort of the UE. For example, a UE 1 may be a first apparatus 100, and a UE 2 may be a second apparatus 200.

For example, the UE 1 may select a resource unit corresponding to a specific resource in a resource pool which implies a set of series of resources. In addition, the UE 1 may transmit an SL signal by using the resource unit. For example, a resource pool in which the UE 1 is capable of transmitting a signal may be configured to the UE 2 which is a receiving UE, and the signal of the UE 1 may be detected in the resource pool.

Herein, if the UE 1 is within a connectivity range of the BS, the BS may inform the UE 1 of the resource pool. Otherwise, if the UE 1 is out of the connectivity range of the BS, another UE may inform the UE 1 of the resource pool, or the UE 1 may use a pre-configured resource pool.

In general, the resource pool may be configured in unit of a plurality of resources, and each UE may select a unit of one or a plurality of resources to use it in SL signal transmission thereof.

Hereinafter, resource allocation in SL will be described.

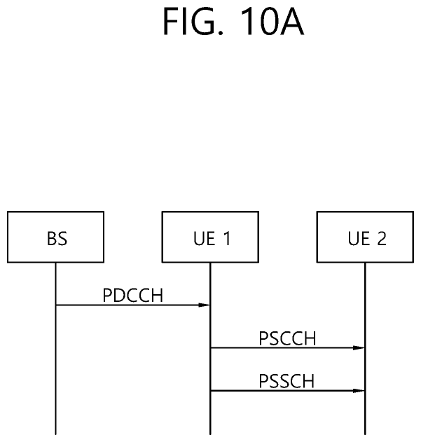

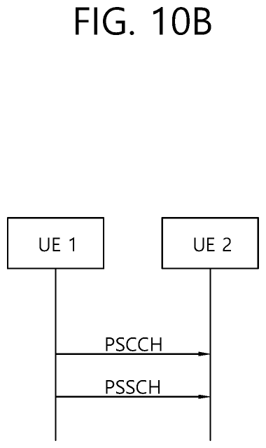

FIGS. 10A and 10B show a procedure of performing V2X or SL communication by a UE based on a transmission mode, based on an embodiment of the present disclosure. The embodiment of FIGS. 10A and 10B may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 10A shows a UE operation related to an LTE transmission mode 1 or an LTE transmission mode 3. Alternatively, for example, FIG. 10A shows a UE operation related to an NR resource allocation mode 1. For example, the LTE transmission mode 1 may be applied to general SL communication, and the LTE transmission mode 3 may be applied to V2X communication.

For example, FIG. 10B shows a UE operation related to an LTE transmission mode 2 or an LTE transmission mode 4. Alternatively, for example, FIG. 10B shows a UE operation related to an NR resource allocation mode 2.

Referring to FIG. 10A, in the LTE transmission mode 1, the LTE transmission mode 3, or the NR resource allocation mode 1, a BS may schedule an SL resource to be used by the UE for SL transmission. For example, the BS may perform resource scheduling to a UE 1 through a PDCCH (more specifically, downlink control information (DCI)), and the UE 1 may perform V2X or SL communication with respect to a UE 2 according to the resource scheduling. For example, the UE 1 may transmit a sidelink control information (SCI) to the UE 2 through a physical sidelink control channel (PSCCH), and thereafter transmit data based on the SCI to the UE 2 through a physical sidelink shared channel (PSSCH).

Referring to FIG. 10B, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannels. In addition, the UE 1 which has autonomously selected the resource within the resource pool may transmit the SCI to the UE 2 through a PSCCH, and thereafter may transmit data based on the SCI to the UE 2 through a PSSCH.

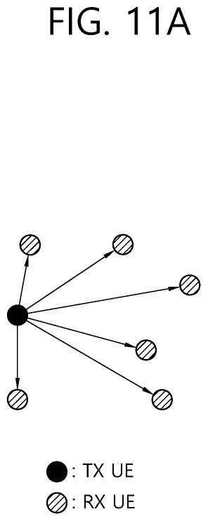

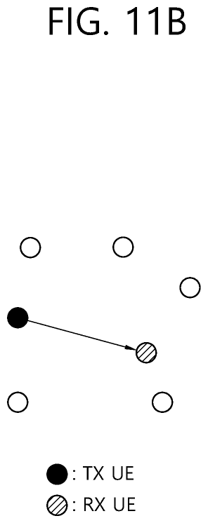

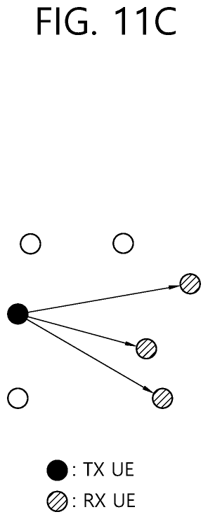

FIGS. 11A to 11C show three cast types, based on an embodiment of the present disclosure. The embodiment of FIGS. 11A to 11C may be combined with various embodiments of the present disclosure. Specifically, FIG. 11A shows broadcast-type SL communication, FIG. 11B shows unicast type-SL communication, and FIG. 11C shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Meanwhile, in SL communication, a UE needs to efficiently select resource(s) for SL transmission. Hereinafter, based on various embodiments of the present disclosure, a method for a UE to efficiently select resource(s) for SL transmission and an apparatus supporting the same will be described. In various embodiments of the present disclosure, SL communication may include V2X communication.

At least one of the methods that are proposed based on the various embodiments of the present disclosure may be applied to at least one of unicast communication, groupcast communication, and/or broadcast communication.

At least one of the methods that are proposed based on the various embodiments of the present disclosure may be applied not only to PC5 interface or SL interface (e.g., PSCCH, PSSCH, PSBCH, PSSS/SSSS, and so on) based SL communication or V2X communication but also to Uu interface (e.g., PUSCH, PDSCH, PDCCH, PUCCH, and so on) based SL communication or V2X communication.

In the various embodiments of the present disclosure, receiving operation(s) of the UE may include decoding operation(s) and/or receiving operation(s) of SL channel(s) and/or SL signal(s) (e.g., PSCCH, PSSCH, PSFCH, PSBCH, PSSS/SSSS, and so on). Receiving operation(s) of the UE may include decoding operation(s) and/or receiving operation(s) of WAN DL channel(s) and/or WAN DL signal(s) (e.g., PDCCH, PDSCH, PSS/SSS, and so on). Receiving operation(s) of the UE may include sensing operation(s) and/or channel busy ratio (CBR) measuring operation(s). In the various embodiments of the present disclosure, sensing operation(s) of the UE may include PSSCH-RSRP measuring operation(s) based on PSSCH DM-RS sequence(s), PSSCH-RSRP measuring operation(s) based on PSSCH DM-RS sequence(s), which is scheduled by a PSCCH that is successfully decoded by the UE, sidelink RSSI (S-RSSI) measuring operation(s), and/or S-RSSI measuring operation(s) based on subchannel(s) related to V2X resource pool(s). In the various embodiments of the present disclosure, transmitting operation(s) of the UE may include transmitting operation(s) of SL channel(s) and/or SL signal(s) (e.g., PSCCH, PSSCH, PSFCH, PSBCH, PSSS/SSSS, and so on). Transmitting operation(s) may include transmitting operation(s) of WAN UL channel(s) and/or WAN UL signal(s) (e.g., PUSCH, PUCCH, SRS, and so on). In the various embodiments of the present disclosure, a synchronization signal may include an SLSS and/or a PSBCH.

In the various embodiments of the present disclosure, configuration may include signaling, signaling from a network, configuration from a network, and/or a pre-configuration from a network. In the various embodiments of the present disclosure, definition may include signaling, signaling from a network, configuration from a network, and/or a pre-configuration from a network. In the various embodiments of the present disclosure, designation may include signaling, signaling from a network, configuration from a network, and/or a pre-configuration from a network.

In the various embodiments of the present disclosure, ProSe Per Packet Priority (PPPP) may be replaced with ProSe Per Packet Reliability (PPPR), and PPPR may be replaced with PPPP. For example, as the PPPP value becomes smaller, this may indicate a high priority, and, as the PPPP value becomes greater, this may indicate a low priority. For example, as the PPPR value becomes smaller, this may indicate a high reliability, and, as the PPPR value becomes greater, this may indicate a low reliability. For example, a PPPP value related to a service, a packet or a message being related to a high priority may be smaller than a PPPP value related to a service, a packet or a message being related to a low priority. For example, a PPPR value related to a service, a packet or a message being related to a high reliability may be smaller than a PPPR value related to a service, a packet or a message being related to a low reliability.

Meanwhile, in the present disclosure, a high priority may mean a small priority value, and a low priority may mean a large priority value. For example, Table 5 shows an example of priorities.

TABLE 5

| service or | priority |
|---|---|
| logical channel | value |
| service A or logical channel A | 1 |
| service B or logical channel B | 2 |
| service C or logical channel C | 3 |

Referring to Table 5, for example, service A or logical channel A related to the smallest priority value may have the highest priority. For example, service C or logical channel C related to the largest priority value may have the lowest priority.

In the various embodiments of the present disclosure, a session may include at least one of a unicast session (e.g., a unicast session for SL), a groupcast/multicast session (e.g., a groupcast/multicast session for SL), and/or a broadcast session (e.g., a broadcast session for SL).

In the various embodiments of the present disclosure, a carrier may be replaced with at least one of a BWP and/or a resource pool, or vice versa. For example, a carrier may include at least one of a BWP and/or a resource pool. For example, a carrier may include one or more BWPs. For example, a BWP may include one or more resource pools.

Meanwhile, in the present disclosure, for example, a transmitting UE (TX UE) may be a UE which transmits data to a (target) receiving UE (RX UE). For example, the TX UE may be a UE which performs PSCCH transmission and/or PSSCH transmission. And/or, for example, the TX UE may be a UE which transmits SL CSI-RS(s) and/or a SL CSI report request indicator to the (target) RX UE. And/or, for example, the TX UE may be a UE which transmits a (control) channel (e.g., PSCCH, PSSCH, etc.) and/or reference signal(s) on the (control) channel (e.g., DM-RS, CSI-RS, etc.), to be used for a SL RLM operation and/or a SL RLF operation of the (target) RX UE.

Meanwhile, in the present disclosure, for example, a receiving UE (RX UE) may be a UE which transmits SL HARQ feedback to a transmitting UE (TX UE) based on whether decoding of data received from the TX UE is successful and/or whether detection/decoding of a PSCCH (related to PSSCH scheduling) transmitted by the TX UE is successful. And/or, for example, the RX UE may be a UE which performs SL CSI transmission to the TX UE based on SL CSI-RS(s) and/or a SL CSI report request indicator received from the TX UE. And/or, for example, meanwhile, in the present disclosure, for example, a transmitting UE (TX UE) may be a UE which transmits data to a (target) receiving UE (RX UE). For example, the TX UE may be a UE which performs PSCCH transmission and/or PSSCH transmission. And/or, for example, the TX UE may be a UE which transmits SL CSI-RS(s) and/or a SL CSI report request indicator to the (target) RX UE. And/or, for example, the TX UE may be a UE which transmits a (control) channel (e.g., PSCCH, PSSCH, etc.) and/or reference signal(s) on the (control) channel (e.g., DM-RS, CSI-RS, etc.), to be used for a SL radio link monitoring (RLM) operation and/or a SL radio link failure (RLF) operation of the (target) RX UE.

Meanwhile, in the present disclosure, for example, a receiving UE (RX UE) may be a UE which transmits SL HARQ feedback to a transmitting UE (TX UE) based on whether decoding of data received from the TX UE is successful and/or whether detection/decoding of a PSCCH (related to PSSCH scheduling) transmitted by the TX UE is successful. And/or, for example, the RX UE may be a UE which performs SL CSI transmission to the TX UE based on SL CSI-RS(s) and/or a SL CSI report request indicator received from the TX UE. And/or, for example, the RX UE is a UE which transmits a SL (L1) reference signal received power (RSRP) measurement value, to the TX UE, measured based on (pre-defined) reference signal(s) and/or a SL (L1) RSRP report request indicator received from the TX UE. And/or, for example, the RX UE may be a UE which transmits data of the RX UE to the TX UE. And/or, for example, the RX UE may be a UE which performs a SL RLM operation and/or a SL RLF operation based on a (pre-configured) (control) channel and/or reference signal(s) on the (control) channel received from the TX UE.

Meanwhile, in the present disclosure, for example, in case the RX UE transmits SL HARQ feedback information for a PSSCH and/or a PSCCH received from the TX UE, the following options or some of the following options may be considered. Herein, for example, the following options or some of the following options may be limitedly applied only if the RX UE successfully decodes/detects a PSCCH scheduling a PSSCH.

(1) groupcast HARQ feedback option 1: NACK information may be transmitted to the TX UE only if the RX UE fails to decode/receive the PSSCH received from the TX UE.

(2) groupcast HARQ feedback option 2: If the RX UE succeeds in decoding/receiving the PSSCH received from the TX UE, ACK information may be transmitted to the TX UE, and if the RX UE fails to decode/receive the PSSCH, NACK information may be transmitted to the TX UE.

Meanwhile, in the present disclosure, for example, the TX UE may transmit the following information or some of the following information to the RX UE through SCI(s). Herein, for example, the TX UE may transmit some or all of the following information to the RX UE through a first SCI and/or a second SCI.
PSSCH (and/or PSCCH) related resource allocation information (e.g., the location/number of time/frequency resources, resource reservation information (e.g., period))
SL CSI report request indicator or SL (L1) reference signal received power (RSRP) (and/or SL (L1) reference signal received quality (RSRQ) and/or SL (L1) reference signal strength indicator (RSSI)) report request indicator
SL CSI transmission indicator (or SL (L1) RSRP (and/or SL (L1) RSRQ and/or SL (L1) RSSI) information transmission indicator) (on a PSSCH)
Modulation and Coding Scheme (MCS) information
TX power information
L1 destination ID information and/or L1 source ID information
SL HARQ process ID information
New Data Indicator (NDI) information
Redundancy Version (RV) information
(Transmission traffic/packet related) QoS information (e.g., priority information)
SL CSI-RS transmission indicator or information on the number of antenna ports for (transmitting) SL CSI-RS
TX UE location information or location (or distance range) information of the target RX UE (for which SL HARQ feedback is requested)
Reference signal (e.g., DM-RS, etc.) information related to decoding (and/or channel estimation) of data transmitted through a PSSCH. For example, information related to a pattern of (time-frequency) mapping resources of DM-RS(s), RANK information, antenna port index information, information on the number of antenna ports, etc.

Meanwhile, in the present disclosure, for example, since the TX UE may transmit a SCI, a first SCI and/or a second SCI to the RX UE through a PSCCH, the PSCCH may be replaced/substituted with the SCI and/or the first SCI and/or the second SCI. Additionally/alternatively, the SCI may be replaced/substituted with the PSCCH and/or the first SCI and/or the second SCI. Additionally/alternatively, for example, since the TX UE may transmit a second SCI to the RX UE through a PSSCH, the PSSCH may be replaced/substituted with the second SCI.

Meanwhile, in the present disclosure, for example, if SCI configuration fields are divided into two groups in consideration of a (relatively) high SCI payload size, the first SCI including a first SCI configuration field group may be referred to as a 1^{st} SCI, and the second SCI including a second SCI configuration field group may be referred to as a 2^{nd} SCI. Also, for example, the 1^{st} SCI may be transmitted to the receiving UE through a PSCCH. Also, for example, the 2^{nd} SCI may be transmitted to the receiving UE through a (independent) PSCCH or may be piggybacked and transmitted together with data through a PSSCH.

Meanwhile, in the present disclosure, for example, the term “configure/configured” or the term “define/defined” may refer to (pre)configuration from a base station or a network (through pre-defined signaling (e.g., SIB, MAC, RRC, etc.)) (for each resource pool).

Meanwhile, in the present disclosure, for example, since an RLF may be determined based on out-of-synch (OOS) indicator(s) or in-synch (IS) indicator(s), the RLF may be replaced/substituted with out-of-synch (OOS) indicator(s) or in-synch (IS) indicator(s).

Meanwhile, in the present disclosure, for example, an RB may be replaced/substituted with a subcarrier. Also, in the present disclosure, for example, a packet or a traffic may be replaced/substituted with a TB or a MAC PDU based on a transmission layer.

Meanwhile, in the present disclosure, a CBG may be replaced/substituted with a TB.

Meanwhile, in the present disclosure, for example, a source ID may be replaced/substituted with a destination ID.

Meanwhile, in the present disclosure, for example, an L1 ID may be replaced/substituted with an L2 ID. For example, the L1 ID may be an L1 source ID or an L1 destination ID. For example, the L2 ID may be an L2 source ID or an L2 destination ID.

Meanwhile, in the present disclosure, for example, an operation of the transmitting UE to reserve/select/determine retransmission resource(s) may include: an operation of the transmitting UE to reserve/select/determine potential retransmission resource(s) for which actual use will be determined based on SL HARQ feedback information received from the receiving UE.

Meanwhile, in the present disclosure, a sub-selection window may be replaced/substituted with a selection window and/or the pre-configured number of resource sets within the selection window, or vice versa.

Meanwhile, in the present disclosure, SL MODE 1 may refer to a resource allocation method or a communication method in which a base station directly schedules SL transmission resource(s) for a TX UE through pre-defined signaling (e.g., DCI or RRC message). For example, SL MODE 2 may refer to a resource allocation method or a communication method in which a UE independently selects SL transmission resource(s) in a resource pool pre-configured or configured from a base station or a network. For example, a UE performing SL communication based on SL MODE 1 may be referred to as a MODE 1 UE or MODE 1 TX UE, and a UE performing SL communication based on SL MODE 2 may be referred to as a MODE 2 UE or MODE 2 TX UE.

Meanwhile, in the present disclosure, for example, a dynamic grant (DG) may be replaced/substituted with a configured grant (CG) and/or a semi-persistent scheduling (SPS) grant, or vice versa. For example, the DG may be replaced/substituted with a combination of the CG and the SPS grant, or vice versa. For example, the CG may include at least one of a configured grant (CG) type 1 and/or a configured grant (CG) type 2. For example, in the CG type 1, a grant may be provided by RRC signaling and may be stored as a configured grant. For example, in the CG type 2, a grant may be provided by a PDCCH, and may be stored or deleted as a configured grant based on L1 signaling indicating activation or deactivation of the grant.

Meanwhile, in the present disclosure, a channel may be replaced/substituted with a signal, or vice versa. For example, transmission/reception of a channel may include transmission/reception of a signal. For example, transmission/reception of a signal may include transmission/reception of a channel.

Meanwhile, in the present disclosure, cast may be replaced/substituted with at least one of unicast, groupcast, and/or broadcast, or vice versa. For example, a cast type may be replaced/substituted with at least one of unicast, groupcast, and/or broadcast, or vice versa. For example, the cast or the cast type may include unicast, groupcast and/or broadcast.

Meanwhile, in the present disclosure, a resource may be replaced/substituted with a slot or a symbol, or vice versa. For example, the resource may include a slot and/or a symbol.

Meanwhile, in the present disclosure, a priority may be replaced/substituted with at least one of logical channel prioritization (LCP), latency, reliability, minimum required communication range, prose per-packet priority (PPPP), sidelink radio bearer (SLRB), QoS profile, QoS parameter and/or requirement, or vice versa.

Meanwhile, in the present disclosure, for example, for convenience of description, a (physical) channel used when a RX UE transmits at least one of the following information to a TX UE may be referred to as a PSFCH.
SL HARQ feedback, SL CSI, SL (L1) RSRP

Meanwhile, in the present disclosure, a Uu channel may include a UL channel and/or a DL channel. For example, the UL channel may include a PUSCH, a PUCCH, etc. For example, the DL channel may include a PDCCH, a PDSCH, etc. For example, a SL channel may include a PSCCH, a PSSCH, a PSFCH, a PSBCH, etc.

Meanwhile, in the present disclosure, sidelink information may include at least one of a sidelink message, a sidelink packet, a sidelink service, sidelink data, sidelink control information, and/or a sidelink transport block (TB). For example, sidelink information may be transmitted through a PSSCH and/or a PSCCH.

Meanwhile, in NR V2X communication or NR sidelink communication, the transmitting UE may reserve/select one or more transmission resources for sidelink transmission (e.g., initial transmission and/or retransmission), and the transmitting UE may inform the receiving UE of information on the location of the one or more transmission resources.

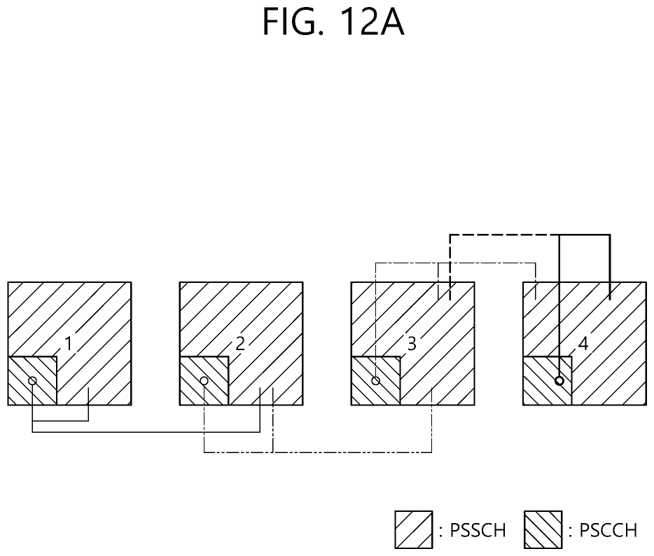

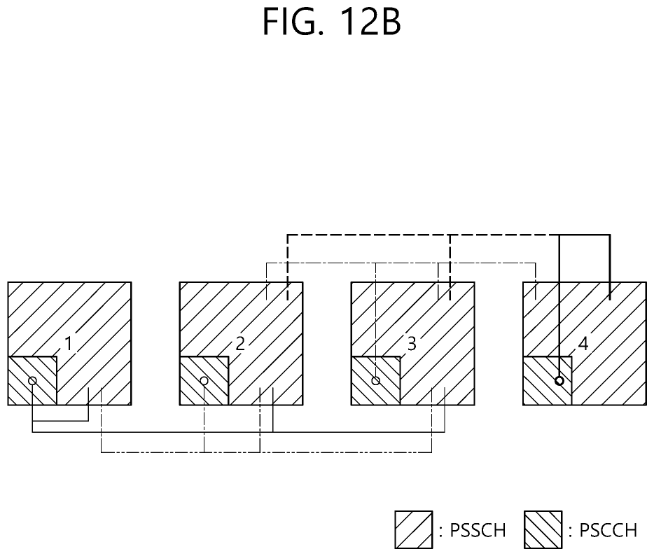

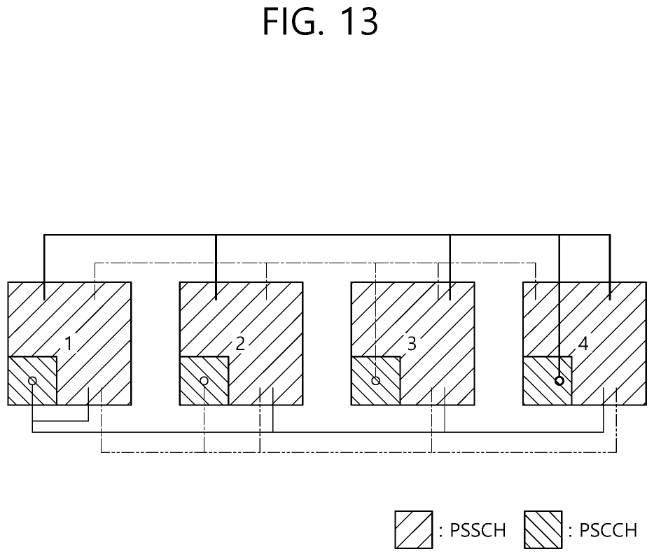

Meanwhile, when performing sidelink communication, for example, a method for the transmitting UE to reserve or pre-determine a transmission resource for the receiving UE may be based on the embodiments of FIG. 12A, FIG. 12B or FIG. 13 to be described below.

FIGS. 12A and 12B show an example of chain-based resource reservation.

For example, the transmitting UE may perform the reservation of the transmission resources based on CHAIN. Specifically, for example, when the transmitting UE performs reservation of K number of transmission resources, location information of transmission resources less than K may be transmitted or informed to the receiving UE through SCI transmitted to the receiving UE at any (or specific) transmission time point or time resource. That is, for example, the SCI may include location information of transmission resources less than K. Or, for example, when the transmitting UE reserves K number of transmission resources related to a specific TB, location information of transmission resources less than K may be transmitted or informed to the receiving UE through SCI transmitted to the receiving UE at any (or specific) transmission time point or time resource. That is, the SCI may include location information of transmission resources less than K. At this time, for example, the transmitting UE signals only the location information of transmission resources less than K to the receiving UE through one SCI transmitted at any (or specific) transmission time point or time resource, thereby preventing performance degradation due to excessive increase in SCI PAYLOAD. Specifically, for example, FIG. 12A shows a method for the transmitting UE to perform CHAIN-based resource reservation, when the value of K is 4 and the transmitting UE signals location information of (maximum) two transmission resources to the receiving UE through one SCI. Also, for example, FIG. 12B shows a method for the transmitting UE to perform CHAIN-based resource reservation, when the value of K is 4 and the transmitting UE signals location information of (maximum) three transmission resources to the receiving UE through one SCI. For example, in FIGS. 12A and 12B, only location information of the fourth transmission-related resource may be transmitted/signaled to the receiving UE through the fourth (or last) transmission-related PSCCH transmitted by the transmitting UE. And/or, for example, in FIG. 12A, location information of the third transmission-related resource may be additionally transmitted/signaled to the receiving UE through the fourth (or last) transmission-related PSCCH transmitted by the transmitting UE. And/or, for example, in FIG. 12B, location information of the second transmission and the third transmission-related resource may be additionally transmitted/signaling to the receiving UE through the fourth (or last) transmission-related PSCCH transmitted by the transmitting UE. At this time, for example, when only location information of the fourth transmission-related resource is transmitted/signaled to the receiving UE through the fourth (or last) transmission-related PSCCH transmitted by the transmitting UE in FIGS. 12A and 12B, the transmitting UE may configured or designate a location information field/bit of an unused or remaining transmission resource to a pre-configured value (e.g., 0). Or, for example, when only location information of the fourth transmission-related resource is transmitted/signaled to the receiving UE through the fourth (or last) transmission-related PSCCH transmitted by the transmitting UE in FIGS. 12A and 12B, the transmitting UE may configure or designate a location information field/bit of an unused or remaining transmission resource to indicate a pre-configured status/bit value indicating that it is the last transmission (among the four transmissions).

FIG. 13 shows an example of block-based resource reservation.

For example, the transmitting UE may perform the reservation of the transmission resources based on BLOCK. Specifically, for example, when the transmitting UE performs reservation of K number of transmission resources, all location information related to the K number of transmission resources may be transmitted or informed to the receiving UE through SCI transmitted to the receiving UE at any (or specific) transmission time point or time resource. That is, the SCI may include location information of the K number of transmission resources. Or, for example, when the transmitting UE performs reservation of K number of transmission resources related to a specific TB, all location information related to the K number of transmission resources may be transmitted or informed to the receiving UE through SCI transmitted to the receiving UE at any (or specific) transmission time point or time resource. That is, the SCI may include location information of the K number of transmission resources. For example, FIG. 13 shows a method for the transmitting UE to perform BLOCK-based resource reservation by signaling location information of four transmission resources to the receiving UE through one SCI, when the value of K is 4.

Meanwhile, if a SL HARQ feedback operation is configured/applied to the UE performing SL communication, service-related requirements (e.g., reliability, error rate, etc.) may be efficiently satisfied. To this end, for example, the TX UE may transmit SL information through a PSSCH and/or a PSCCH, and the RX UE may transmit SL HARQ feedback information through a PSFCH. For example, the TX UE may transmit SL information to a target RX UE of the TX UE through the PSSCH and/or the PSCCH. For example, the RX UE may be a target RX UE of the TX UE. For example, the RX UE may transmit SL HARQ feedback information to the TX UE through the PSFCH. For example, the composition of the SL HARQ feedback information and/or the amount of the SL HARQ feedback information (e.g., the number of bits) transmitted by the RX UE through the PSFCH may be determined/defined based on some or all of the following schemes.

1) dynamic codebook

For example, the composition of SL HARQ feedback information and/or the amount of SL HARQ feedback information transmitted by the RX UE through the PSFCH may be determined/defined based on a dynamic codebook. In this case, for example, based on the number of (new) TBs transmitted by the TX UE, the RX UE may change/determine the amount of SL HARQ feedback information to be transmitted. For example, based on the number of (new) TBs transmitted by the TX UE, the RX UE may change/determine the amount of SL HARQ feedback information to be transmitted to the TX UE.

For example, if the RX UE fails to decode a PSCCH, for example, if the RX UE fails to decode the PSCCH transmitted by the TX UE, the TX UE should perform blind decoding for the amount of SL HARQ feedback information transmitted by the RX UE through the PSFCH and/or the PSFCH resource used by the RX UE for transmission of SL HARQ feedback information. For example, based on the amount of SL HARQ feedback information transmitted by the RX UE, the RX UE may generate/transmit SL HARQ feedback information by using phase values the number of different cyclic shifts (CSs) related to a zadoff-chu (ZC) sequence. For example, if the SL HARQ feedback information transmitted by the RX UE is 1 bit, the RX UE may generate/transmit the SL HARQ feedback information by using 2 CS values. For example, if the SL HARQ feedback information transmitted by the RX UE is 2 bits, the RX UE may generate/transmit the SL HARQ feedback information by using 4 CS values. For example, if the TX UE transmits 3 TBs to the RX UE and the RX UE fails to decode a PSCCH related to 1 TB, the RX UE may transmit 2-bit HARQ feedback information to the TX UE. In this case, the TX UE expecting to receive 3-bit HARQ feedback information should perform blind decoding for the HARQ feedback information.

Herein, for example, in order to alleviate the problem that the TX UE performs blind decoding for the amount of SL HARQ feedback information transmitted by the RX UE through the PSFCH and/or the PSFCH resource used by the RX UE for transmission of SL HARQ feedback information, the TX UE may transmit, to the RX UE, a SCI including an indicator field indicating how many times (new) TB transmission the TX UE has performed to the RX UE. For example, the SCI may be a 2^{nd} SCI.

2) (semi) static codebook

For example, the composition of SL HARQ feedback information and/or the amount of SL HARQ feedback information transmitted by the RX UE through the PSFCH may be determined/defined based on a (semi) static codebook.

For example, the number of slots of a PSSCH resource related to a PSFCH resource and/or the number of slots of a PSCCH resource related to the PSFCH resource may be configured or pre-configured for the UE. For example, the number of slots of the PSSCH resource related to the PSFCH resource and/or the number of slots of the PSCCH resource related to the PSFCH resource may be configured or pre-configured for the UE for each resource pool.

And/or, for example, the location of a PSSCH resource related to a PSFCH resource and/or the location of a PSCCH resource related to the PSFCH resource may be configured or pre-configured for the UE. For example, the location of the PSSCH resource related to the PSFCH resource and/or the location of the PSCCH resource related to the PSFCH resource may be configured or pre-configured for the UE for each resource pool.

And/or, for example, an index of a PSSCH resource related to a PSFCH resource and/or an index of a PSCCH resource related to the PSFCH resource may be configured or pre-configured for the UE. For example, the index of the PSSCH resource related to the PSFCH resource and/or the index of the PSCCH resource related to the PSFCH resource may be configured or pre-configured for the UE for each resource pool.

For example, based on at least one of the number of slots of the PSSCH resource related to the PSFCH resource, the number of slots of the PSCCH resource related to the PSFCH resource, the location of the PSSCH resource related to the PSFCH resource, the location of the PSCCH resource related to the PSFCH resource, the index of the PSSCH resource related to the PSFCH resource and/or the index of the PSCCH resource related to the PSFCH resource, the UE may determine the amount of SL HARQ feedback information included in the PSFCH.

For example, the RX UE may preferentially include feedback information related to a PSSCH slot and/or a PSCCH slot with a relatively low index (prior to a PSFCH slot) in SL HARQ feedback information (on a specific PSFCH) sequentially. For example, the RX UE may preferentially include feedback information related to a PSSCH slot and/or a PSCCH slot with a relatively high index (prior to a PSFCH slot) in SL HARQ feedback information (on a specific PSFCH) sequentially. For example, the RX UE may preferentially include feedback information related to a PSSCH slot and/or a PSCCH slot with a pre-configured index (prior to a PSFCH slot) in SL HARQ feedback information (on a specific PSFCH) sequentially. In addition, for example, the RX UE may transmit the SL HARQ feedback information to the TX UE through the specific PSFCH.

Meanwhile, for example, a gNB (performing NR communication) may schedule an LTE MODE 3 SL SPS operation to an NR UE through an NR Uu interface and/or signaling. And/or, for example, the gNB (performing NR communication) may activate or deactivate the LTE MODE 3 SL SPS operation to the NR UE through the NR Uu interface and/or signaling. Herein, for example, the gNB may transmit NR DCI (hereinafter referred to as CRAT_DCI) to the NR UE in order to perform the above-described operation. For example, CRAT_DCI (otherwise referred to as DCI 3_1, DCI FORMAT 3_1, cross-RAT DCI, etc.) may include information related to the LTE MODE 3 SL SPS operation of the NR UE.

Meanwhile, for example, in order to prevent at least one of the (existing) blind decoding (DCI format) budget (of NR Uu), the maximum number of non-overlapping CCEs for channel estimation, the maximum number of search spaces, and/or the maximum number of CORESETs from increasing due to CRAT_DCI, the payload size of NR SL MODE 1 DCI (otherwise referred to as DCI 3_0, DCI FORMAT 3_0, NR sidelink mode 1 DCI, etc.) and the payload size of CRAT_DCI may be configured to be the same. For example, the base station may directly schedule transmission resource(s) used for SL communication to the UE (through NR SL MODE 1 DCI).

However, for example, the base station may independently perform a CRAT_DCI-based LTE MODE 3 SL SPS scheduling/deactivation/activation operation and an NR SL MODE 1 DCI-based SL resource scheduling operation. For example, the base station may independently transmit CRAT_DCI and NR SL MODE 1 DCI to the UE. Therefore, if NR SL MODE 1 DCI does not exist, it may be ambiguous how the base station determines the payload size of CRAT_DCI. For example, if the base station does not configure/transmit NR SL MODE 1 DCI to the UE, it may be ambiguous how the base station determines the payload size of CRAT_DCI.

In other words, when the NR base station (GNB) signals LTE MODE 3 SL SPS scheduling (and/or (de)activation) through pre-configured DCI (DCI 3_1), if the UE is not monitoring DCI (DCI 3_0) related to NR MODE 1 SL scheduling (and/or (de)activation), a method for determining the payload size of DCI 3_1 needs to be defined.

Hereinafter, based on various embodiments of the present disclosure, a method for receiving CRAT_DCI by the UE and device(s) supporting the same are proposed.

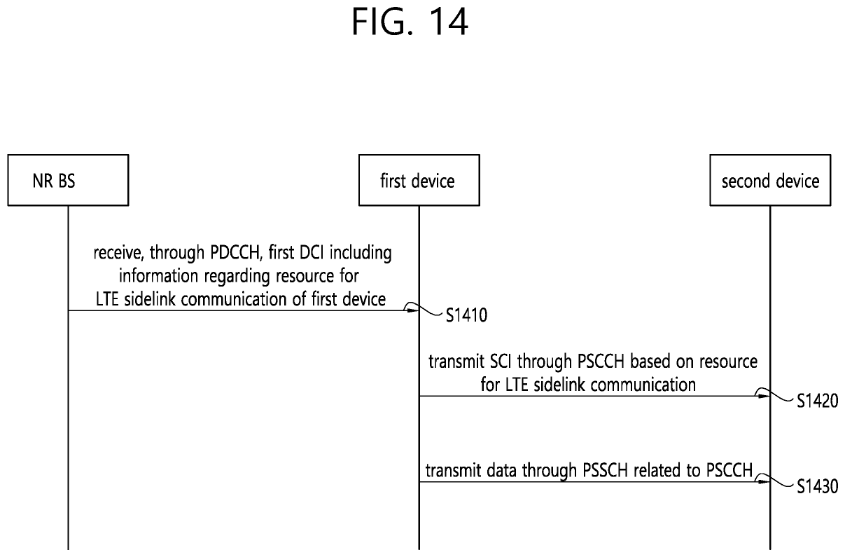

FIG. 14 shows a method for a first device to perform sidelink communication based on DCI received from a NR base station based on an embodiment.

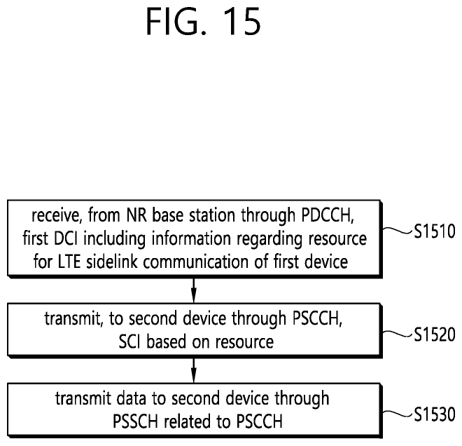

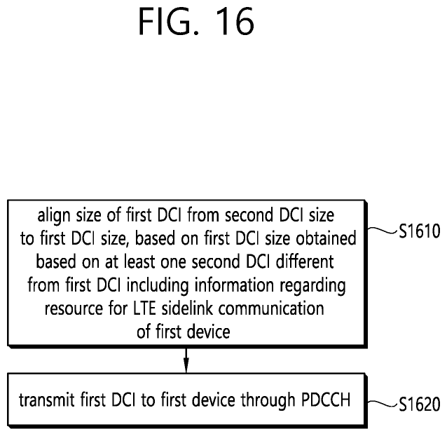

In an embodiment, the first device shown in the flowchart of FIG. 14 may correspond to the first device of FIGS. 15 and 16 described later, and the NR base station shown in the flowchart of FIG. 14 may correspond to the NR base station of FIGS. 15 and 16 described later.

In step S1410, the first device according to an embodiment may receive, from the NR base station (otherwise referred to as the base station) through a PDCCH, first DCI including information regarding resource(s) for LTE sidelink communication of the first device. For example, the first DCI may be the same as or correspond to CRAT_DCI (otherwise referred to as DCI 3_1, DCI FORMAT 3_1, cross-RAT DCI, NR DCI, etc.) described in FIG. 13. In this case, the size of CRAT_DCI may be aligned by the NR base station, and a detailed description thereof will be described later with reference to FIGS. 14 to 16. In step S1420, the first device may transmit SCI to a second device through a PSCCH based on the resource(s) for LTE sidelink communication. In step S1430, the first device may transmit data to the second device through a PSSCH related to the PSCCH.

Hereinafter, various embodiments and examples directly or indirectly related to at least one of steps S1410 to S1430 will be described.

In relation to step S1410, the NR base station (or base station) according to an embodiment may determine or adjust (or align) the size of CRAT_DCI. For example, the base station may perform zero padding for CRAT_DCI, and the base station may align the size of CRAT_DCI with a specific size.

For example, the base station may determine or align the size of CRAT_DCI based on REF_SIZE. For example, the base station may align the size of CRAT_DCI with REF_SIZE. For example, the size of CRAT_DCI may be equal to REF_SIZE. For example, the base station may align the size of CRAT_DCI with REF_SIZE by performing zero padding for CRAT_DCI. For example, REF_SIZE may be a reference value used by the base station to determine or align the size of CRAT_DCI. For example, REF_SIZE may be the size of reference NR SL MODE 1 DCI used by the base station to determine or align the size of CRAT_DCI.

For example, the base station may determine or align the size of CRAT_DCI based on parameters for determining the size of (VIRTUAL) NR SL MODE 1 DCI. For example, the parameters for determining the size of (VIRTUAL) NR SL MODE 1 DCI may include at least one of the number of subchannels on a slot, the number of subchannels on a slot in a resource pool, information related to a resource pool configuration, and/or the number of (maximum) transmission resources that can be scheduled/reserved through one SCI.

For example, the base station may determine or align the size of CRAT_DCI based on information related to NR Uu DCI. For example, information related to NR Uu DCI may include fallback DCI transmitted on a UE-specific search space or C-RNTI-based fallback DCI transmitted on a UE-specific search space. For example, information related to NR Uu DCI may include non-fallback DCI transmitted on a UE-specific search space or a C-RNTI-based non-fallback DCI transmitted on a UE-specific search space.

In an embodiment, the base station/network may configure or pre-configure information related to the size of CRAT_DCI to the UE through predefined signaling. For example, the base station/network may transmit information related to the size of CRAT_DCI to the UE through predefined signaling. For example, information related to the size of CRAT_DCI may include at least one of information related to REF_SIZE, information related to parameters for determining the size of (VIRTUAL) NR SL MODE 1 DCI, and/or information related to NR Uu DCI. For example, the predefined signaling may be RRC signaling and/or SIB.

In an embodiment, the UE may determine or assume the size of CRAT_DCI transmitted by the base station based on information related to the size of CRAT_DCI. In addition, for example, the UE may receive CRAT_DCI from the base station. For example, the UE may decode CRAT_DCI.

For example, information related to the (DCI) size used to determine the size of CRAT_DCI configured through the (some) rule may be (always) greater than or equal to the size of CRAT_DCI. Or, for example, information related to the (DCI) size used to determine the size of CRAT_DCI configured through the (some) rule may be (always) greater than the size of CRAT_DCI.

Based on an embodiment of the present disclosure, the base station may determine or align the size of CRAT_DCI based on the size of NR Uu DCI transmitted through a (partially) overlapping search space. For example, the base station may align the size of CRAT_DCI with NR Uu DCI transmitted through a (partially) overlapping search space, by performing zero padding for CRAT_DCI. For example, the base station may use NR Uu DCI having the smallest size difference, among NR Uu DCIs having a size greater than or equal to the size of CRAT_DCI, to determine or align the size of CRAT_DCI. In addition, for example, the UE may determine or assume the size of CRAT_DCI based on NR Uu DCI having the smallest size difference among NR Uu DCIs having a size greater than or equal to the size of CRAT_DCI. In addition, for example, the UE may receive CRAT_DCI from the base station. For example, the UE may decode CRAT_DCI.

Based on an embodiment of the present disclosure, the size determination or the size alignment operation between CRAT_DCI and NR SL MODE 1 DCI of the base station or the UE may be limitedly performed only when the NR SL MODE 1 operation is configured for the UE.

Based on an embodiment of the present disclosure, only if the gNB (performing NR communication) configures an NR SL MODE 1 operation for the NR UE, the gNB may schedule the LTE MODE 3 SL SPS operation to the NR UE through an NR Uu interface and/or signaling (e.g., CRAT_DCI). And/or, for example, only if the gNB (performing NR communication) configures the NR SL MODE 1 operation for the NR UE, the gNB may activate or deactivate the LTE MODE 3 SL SPS operation for the NR UE through the NR Uu interface and/or signaling (e.g., CRAT_DCI). For example, the case in which the gNB configures the NR SL MODE 1 operation for the NR UE may include a case in which the gNB schedules/allocates SL related resource(s) to the NR UE through NR Uu DCI. Through this, the base station can always align the size of CRAT_DCI and the size of NR SL MODE 1 DCI. For example, a size fitting operation between CRAT_DCI and NR SL MODE 1 DCI of the base station can always be guaranteed.

Based on an embodiment of the present disclosure, if NR SL MODE 1 DCI does not exist, the base station may align the size of CRAT_DCI and the size of a NR Uu DCI format (e.g., DCI format_REF). For example, the NR Uu DCI format may be DCI format(s) configured/defined in the existing NR Uu. For example, DCI format_REF aligned with CRAT_DCI may be configured/signaled in advance. For example, the base station may configure or determine the size of CRAT_DCI and the size of DCI format_REF to be the same.

For example, if the size of CRAT_DCI is greater than the size of (existing) (all) DCI format_REF, the base station may align the size of a NR Uu DCI format with the size of CRAT_DCI by performing zero padding for the NR Uu DCI format configured/signaled in advance.

And/or, for example, if the size of CRAT_DCI is greater than the size of (existing) (all) DCI format_REF, the base station may align the size of a DCI format_REF with the size of CRAT_DCI by performing zero padding for the DCI format_REF having the smallest difference from the size of CRAT_DCI. For example, the base station may select or determine the DCI format_REF having the smallest difference from the size of CRAT_DCI, regardless of (associated) search space type and/or NR Uu DCI format.

And/or, for example, if the size of CRAT_DCI is greater than the size of (existing) (all) DCI format_REF, the base station may align the size of a fallback DCI format_REF with the size of CRAT_DCI, by (preferentially) performing zero padding for the fallback DCI format_REF (pre-configured/signaled) on a UE-specific search space (USS). For example, if the size of CRAT_DCI is greater than the size of (existing) (all) DCI format_REF, the base station may align the size of the fallback DCI format_REF with the size of CRAT_DCI, by preferentially performing zero padding for the fallback DCI format_REF (pre-configured/signaled) on the USS, compared with a DCI format_REF on a common search space (CSS).

And/or, for example, if the size of CRAT_DCI is greater than the size of (existing) (all) DCI format_REF, the base station may align the size of a non-fallback DCI format_REF with the size of CRAT_DCI, by (preferentially) performing zero padding for the non-fallback DCI format_REF (pre-configured/signaled) on a USS. For example, if the size of CRAT_DCI is greater than the size of (existing) (all) DCI format_REF, the base station may align the size of the non-fallback DCI format_REF with the size of CRAT_DCI, by preferentially performing zero padding for the non-fallback DCI format_REF (pre-configured/signaled) on the USS, compared with a DCI format_REF on a CSS.

And/or, for example, if the size of CRAT_DCI is greater than the size of (existing) (all) DCI format_REF, the base station may align the size of a fallback DCI format_REF with the size of CRAT_DCI, by (preferentially) performing zero padding for the fallback DCI format_REF having the smallest difference from the size of CRAT_DCI among fallback DCI format_REFS on a USS.

And/or, for example, if the size of CRAT_DCI is greater than the size of (existing) (all) DCI format_REF, the base station may align the size of a non-fallback DCI format_REF with the size of CRAT_DCI, by (preferentially) performing zero padding for the non-fallback DCI format_REF having the smallest difference from the size of CRAT_DCI among non-fallback DCI format_REFs on a USS.

And/or, for example, if the size of CRAT_DCI is greater than the size of (existing) (all) DCI format_REF, the base station may align the size of a fallback DCI format_REF with the size of CRAT_DCI, by (preferentially) performing zero padding for the fallback DCI format_REF having the smallest difference from the size of CRAT_DCI among fallback DCI format_REFs on a CSS.

And/or, for example, if the size of CRAT_DCI is greater than the size of (existing) (all) DCI format_REF, the base station may align the size of a non-fallback DCI format_REF with the size of CRAT_DCI, by (preferentially) performing zero padding for the non-fallback DCI format_REF having the smallest difference from the size of CRAT_DCI among non-fallback DCI format_REFs on a CSS.

And/or, for example, if the size of CRAT_DCI is greater than the size of (existing) (all) DCI format_REF, the base station may align the size of a DCI format_REF with the size of CRAT_DCI, by (preferentially) performing zero padding for the DCI format_REF detected/decoded based on a pre-configured RNTI type (e.g., C-RNTI). And/or, for example, if the size of CRAT_DCI is greater than the size of (existing) (all) DCI format_REF, the base station may align the size of a DCI format_REF with the size of CRAT_DCI, by performing zero padding for the DCI format_REF having the smallest difference from the size of CRAT_DCI among DCI format_REFs detected/decoded based on a pre-configured RNTI type (e.g., C-RNTI). In this case, for example, RNTI related to an NR Uu DCI format that a specific UE attempts to decode may take precedence over RNTI related to an NR Uu DCI format that a plurality of UEs commonly attempt to decode. For example, the base station may (preferentially) perform zero padding for a DCI format_REF detected/decoded based the RNTI related to the NR Uu DCI format that the specific UE attempts to decode, compared to a DCI format_REF detected/decoded based on the RNTI related to the NR Uu DCI format that the plurality of UEs commonly attempt to decode.

As described above, the base station may align the size of a specific DCI format_REF with the size of CRAT_DCI, by performing zero padding for the specific DCI format_REF. In addition, for example, the base station may transmit the zero-padded specific DCI format_REF and/or CRAT_DCI to the UE. In addition, for example, the UE may determine or assume that the size of the specific DCI format_REF and the size of CRAT_DCI are the same, and the UE may receive/decode the specific DCI format_REF and/or CRAT_DCI.

For example, if the size of CRAT_DCI is less than the size of (existing) (all) DCI format_REF, the base station may pre-configure/transmit/signal information regarding an NR Uu DCI format used to align the size of CRAT_DCI to the UE. For example, the base station may align the size of CRAT_DCI with the size of a pre-configured NR Uu DCI format, by performing zero padding for CRAT_DCI.

And/or, for example, if the size of CRAT_DCI is less than the size of (existing) (all) DCI format_REF, the base station may align the size of CRAT_DCI with the size of a DCI format_REF, by performing zero padding for CRAT_DCI based on the DCI format_REF having the smallest difference from the size of CRAT_DCI. For example, the base station may select or determine a DCI format_REF having the smallest difference from the size of CRAT_DCI regardless of (associated) search space type and/or NR Uu DCI format.

And/or, for example, if the size of CRAT_DCI is less than the size of (existing) (all) DCI format_REF, the base station may align the size of CRAT_DCI with the size of a fallback DCI format_REF, by (preferentially) performing zero padding for CRAT_DCI based on the fallback DCI format_REF (pre-configured/signaled) on a USS. For example, if the size of CRAT_DCI is less than the size of (existing) (all) DCI format_REF, the base station may align the size of CRAT_DCI with the size of the fallback DCI format_REF, by (preferentially) performing zero padding for CRAT_DCI based on the fallback DCI format_REF (pre-configured/signaled) on the USS, compared with a DCI format_REF on a CSS.

And/or, for example, if the size of CRAT_DCI is less than the size of (existing) (all) DCI format_REF, the base station may align the size of CRAT_DCI with the size of a non-fallback DCI format_REF, by (preferentially) performing zero padding for CRAT_DCI based on the non-fallback DCI format_REF (pre-configured/signaled) on a USS. For example, if the size of CRAT_DCI is less than the size of (existing) (all) DCI format_REF, the base station may align the size of CRAT_DCI with the size of the non-fallback DCI format_REF, by (preferentially) performing zero padding for CRAT_DCI based on the non-fallback DCI format_REF (pre-configured/signaled) on the USS, compared with a DCI format_REF on a CSS.

And/or, for example, if the size of CRAT_DCI is less than the size of (existing) (all) DCI format_REF, the base station may align the size of CRAT_DCI with the size of a fallback DCI format_REF, by (preferentially) performing zero padding for CRAT_DCI based on the fallback DCI format_REF having the smallest difference from the size of CRAT_DCI among fallback DCI format_REFs on a USS.

And/or, for example, if the size of CRAT_DCI is less than the size of (existing) (all) DCI format_REF, the base station may align the size of CRAT_DCI with the size of a non-fallback DCI format_REF, by (preferentially) performing zero padding for CRAT_DCI based on the non-fallback DCI format_REF having the smallest difference from the size of CRAT_DCI among non-fallback DCI format_REFs on a USS.

And/or, for example, if the size of CRAT_DCI is less than the size of (existing) (all) DCI format_REF, the base station may align the size of CRAT_DCI with the size of a fallback DCI format_REF, by (preferentially) performing zero padding for CRAT_DCI based on the fallback DCI format_REF having the smallest difference from the size of CRAT_DCI among fallback DCI format_REFs on a CSS.

And/or, for example, if the size of CRAT_DCI is less than the size of (existing) (all) DCI format_REF, the base station may align the size of CRAT_DCI with the size of a non-fallback DCI format_REF, by (preferentially) performing zero padding for CRAT_DCI based on the non-fallback DCI format_REF having the smallest difference from the size of CRAT_DCI among non-fallback DCI format_REFs on a CSS.

And/or, for example, if the size of CRAT_DCI is less than the size of (existing) (all) DCI format_REF, the base station may align the size of CRAT_DCI with the size of a DCI format_REF, by (preferentially) performing zero padding for CRAT_DCI based on the DCI format_REF detected/decoded based on a pre-configured RNTI type (e.g., C-RNTI). And/or, for example, if the size of CRAT_DCI is less than the size of (existing) (all) DCI format_REF, the base station may align the size of CRAT_DCI with the size of a DCI format_REF, by (preferentially) performing zero padding for CRAT_DCI based on the DCI format_REF having the smallest difference from the size of CRAT_DCI among DCI format_REFs detected/decoded based on a pre-configured RNTI type (e.g., C-RNTI). In this case, for example, RNTI related to an NR Uu DCI format that a specific UE attempts to decode may take precedence over RNTI related to an NR Uu DCI format that a plurality of UEs commonly attempt to decode. For example, the base station may perform zero padding for CRAT_DCI based on a DCI format_REF detected/decoded based on the RNTI related to the NR Uu DCI format that the specific UE attempts to decode, compared to a DCI format_REF detected/decoded based on the RNTI related to the NR Uu DCI format that the plurality of UEs commonly attempt to decode.

As described above, the base station may align the size of CRAT_DCI with the size of a specific DCI format_REF, by performing zero padding for CRAT_DCI based on the specific DCI format_REF. In addition, for example, the base station may transmit the specific DCI format_REF and/or zero-padded CRAT_DCI to the UE. In addition, for example, the UE may determine or assume that the size of the specific DCI format_REF and the size of CRAT_DCI are the same, and the UE may receive/decode the specific DCI format_REF and/or CRAT_DCI.

Also, for example, it may be limitedly applied only if blind decoding (DCI format) budget (and/or the maximum number of non-overlapping CCEs for channel estimation and/or the maximum number of search spaces and/or the maximum number of CORESETs) (of (existing) NR UU) exceeds (or cannot be maintained) when it is not performed.

For example, when the base station does not perform the size fitting operation between CRAT_DCI and the (existing) DCI format_REF (or NR Uu DCI format) described above, only if the blind decoding (DCI format) budget, the maximum number of non-overlapping CCEs for channel estimation, the maximum number of search spaces and/or the maximum number of CORESETs (of (existing) NR UU) exceeds a threshold or cannot be maintained, the base station may perform the size fitting operation limitedly.

In an embodiment, it may be assumed that size-fitting related to DCI 3_1 is performed according to the following rule under a situation in which the UE does not perform DCI 3_0 monitoring. For example, if the DCI size budget is exceeded (due to DCI 3_1), the payload size of DCI 3_1 may be fitted based on Uu DCI having the smallest (payload size) difference among Uu DCIs. In other words, if the DCI size budget is not exceeded (due to DCI 3_1), size fitting between DCI 3_1 and Uu DCI may not be performed. For example, the UE may not expect a case in which the DCI size budget is exceeded (due to DCI 3_1) and the payload size of DCI 3_1 is greater than sizes of all Uu DCIs. In other words, if the DCI size budget is exceeded (due to DCI 3_1), the UE may not expect that the gNB configures the payload size of all UU DCIs to be less than DCI 3_1.

In an embodiment, if DCI format 3_0 or DCI format 3_1 is monitored on a cell and the total number of DCI sizes of the DCI formats configured to monitor for the cell and DCI format 3_0 or DCI format 3_1 is more than 4, zeros may be appended to DCI format 3_0 or (DCI format 3_1). Accordingly, 0 may be appended to DCI format 3_0 or DCI format 3_1 until the smallest value of DCI formats configured to monitor for the cell and the payload size is the same.

In an embodiment, the UE is not expected to handle a configuration that results in i) the total number of different DCI sizes configured to monitor for the cell and DCI format 3_0 or DCI format 3_1 is more than 4, and ii) the payload size of DCI format 3_0 or DCI format 3_1 is larger than the payload size of all other DCI formats configured to monitor for the cell.

For example, based on whether the UE performs a chain-based resource reservation operation, the UE may determine whether to apply at least one of the rules proposed in various embodiments of the present disclosure. And/or, for example, based on whether the UE performs a block-based resource reservation operation, the UE may determine whether to apply at least one of the rules proposed in various embodiments of the present disclosure. And/or, for example, based on whether the UE performs a blind retransmission operation, the UE may determine whether to apply at least one of the rules proposed in various embodiments of the present disclosure. And/or, for example, based on whether the UE performs a SL HARQ feedback-based retransmission operation, the UE may determine whether to apply at least one of the rules proposed in various embodiments of the present disclosure. And/or, for example, based on whether the UE performs a configured grant-based resource selection/reservation operation, the UE may determine whether to apply at least one of the rules proposed in various embodiments of the present disclosure. And/or, for example, based on whether the UE performs a dynamic grant-based resource selection/reservation operation, the UE may determine whether to apply at least one of the rules proposed in various embodiments of the present disclosure.

And/or, for example, whether the UE applies at least one of the rules proposed in various embodiments of the present disclosure may be configured differently or limitedly for the UE for each resource pool. And/or, for example, whether the UE applies at least one of the rules proposed in various embodiments of the present disclosure may be configured differently or limitedly for the UE for each service type. And/or, for example, whether the UE applies at least one of the rules proposed in various embodiments of the present disclosure may be configured differently or limitedly for the UE for each service priority. And/or, for example, whether the UE applies at least one of the rules proposed in various embodiments of the present disclosure may be configured differently or limitedly for the UE for each cast type. For example, the cast type may include at least one of unicast, groupcast, and/or broadcast. And/or, for example, whether the UE applies at least one of the rules proposed in various embodiments of the present disclosure may be configured differently or limitedly for the UE for each destination UE. And/or, for example, whether the UE applies at least one of the rules proposed in various embodiments of the present disclosure may be configured differently or limitedly for the UE for each (L1 or L2) destination ID. And/or, for example, whether the UE applies at least one of the rules proposed in various embodiments of the present disclosure may be configured differently or limitedly for the UE for each (L1 or L2) source ID. And/or, for example, whether the UE applies at least one of the rules proposed in various embodiments of the present disclosure may be configured differently or limitedly for the UE for each (service) QoS parameter. For example, the (service) QoS parameter may include at least one of a reliability-related parameter, a latency-related parameter, and/or a (target) BLER-related parameter. And/or, for example, whether the UE applies at least one of the rules proposed in various embodiments of the present disclosure may be configured differently or limitedly for the UE for each (resource pool) congestion level. And/or, for example, whether the UE applies at least one of the rules proposed in various embodiments of the present disclosure may be configured differently or limitedly for the UE for each SL mode type. For example, the SL mode type may include SL mode 1 and/or SL mode 2. And/or, for example, whether the UE applies at least one of the rules proposed in various embodiments of the present disclosure may be configured differently or limitedly for the UE for each grant type. For example, the grant type may include configured grant and/or dynamic grant. And/or, for example, whether the UE applies at least one of the rules proposed in various embodiments of the present disclosure may be configured differently or limitedly for the UE for each packet/message (e.g., TB) size. And/or, for example, whether the UE applies at least one of the rules proposed in various embodiments of the present disclosure may be configured differently or limitedly for the UE for each number of subchannels used by the UE to transmit a PSSCH. And/or, for example, whether the UE applies at least one of the rules proposed in various embodiments of the present disclosure may be configured differently or limitedly for the UE for each number of RBs used by the UE to transmit a PSCCH. And/or, for example, whether the UE applies at least one of the rules proposed in various embodiments of the present disclosure may be configured differently or limitedly for the UE for each number of RBs included in (one) subchannel. And/or, for example, whether the UE applies at least one of the rules proposed in various embodiments of the present disclosure may be configured differently or limitedly for the UE for each number of subchannels included in a resource pool and/or for each number of RBs included in a resource pool. And/or, for example, whether the UE applies at least one of the rules proposed in various embodiments of the present disclosure may be configured differently or limitedly for the UE based on whether the size of (one) subchannel and the size of PSCCH (frequency) resource are the same. And/or, for example, whether the UE applies at least one of the rules proposed in various embodiments of the present disclosure may be configured differently or limitedly for the UE based on whether a (semi)static codebook is configured for the UE.

For example, based on whether the UE performs a chain-based resource reservation operation, a parameter may be configured differently or limitedly for the UE. And/or, for example, based on whether the UE performs a block-based resource reservation operation, the parameter may be configured differently or limitedly for the UE. And/or, for example, based on whether the UE performs a blind retransmission operation, the parameter may be configured differently or limitedly for the UE. And/or, for example, based on whether the UE performs a SL HARQ feedback-based retransmission operation, the parameter may be configured differently or limitedly for the UE. And/or, for example, based on whether the UE performs a configured grant-based resource selection/reservation operation, the parameter may be configured differently or limitedly for the UE. And/or, for example, based on whether the UE performs a dynamic grant-based resource selection/reservation operation, the parameter may be configured differently or limitedly for the UE.

And/or, for example, the parameter may be configured differently or limitedly for the UE for each resource pool. And/or, for example, the parameter may be configured differently or limitedly for the UE for each service type. And/or, for example, the parameter may be configured differently or limitedly for the UE for each service priority. And/or, for example, the parameter may be configured differently or limitedly for the UE for each cast type. For example, the cast type may include at least one of unicast, groupcast, and/or broadcast. And/or, for example, the parameter may be configured differently or limitedly for the UE for each destination UE. And/or, for example, the parameter may be configured differently or limitedly for the UE for each (L1 or L2) destination ID. And/or, for example, the parameter may be configured differently or limitedly for the UE for each (L1 or L2) source ID. And/or, for example, the parameter may be configured differently or limitedly for the UE for each (service) QoS parameter. For example, the (service) QoS parameter may include at least one of a reliability-related parameter, a latency-related parameter, and/or a (target) BLER-related parameter. And/or, for example, the parameter may be configured differently or limitedly for the UE for each (resource pool) congestion level. And/or, for example, the parameter may be configured differently or limitedly for the UE for each SL mode type. For example, the SL mode type may include SL mode 1 and/or SL mode 2. And/or, for example, the parameter may be configured differently or limitedly for the UE for each grant type. For example, the grant type may include configured grant and/or dynamic grant. And/or, for example, the parameter may be configured differently or limitedly for the UE for each packet/message (e.g., TB) size. And/or, for example, the parameter may be configured differently or limitedly for the UE for each number of subchannels used by the UE to transmit a PSSCH. And/or, for example, the parameter may be configured differently or limitedly for the UE for each number of RBs used by the UE to transmit a PSCCH. And/or, for example, the parameter may be configured differently or limitedly for the UE for each number of RBs included in (one) subchannel. And/or, for example, the parameter may be configured differently or limitedly for the UE for each number of subchannels included in a resource pool and/or for each number of RBs included in a resource pool. And/or, for example, the parameter may be configured differently or limitedly for the UE based on whether the size of (one) subchannel and the size of PSCCH (frequency) resource are the same. And/or, for example, the parameter may be configured differently or limitedly for the UE based on whether a (semi)static codebook is configured for the UE.

Based on various embodiments of the present disclosure, even if the base station does not transmit NR SL MODE 1 DCI to the UE, the base station can determine the size of CRAT_DCI. That is, for example, the base station may align the size of CRAT_DCI with a specific size. In addition, the UE can determine or assume the size of CRAT_DCI transmitted by the base station according to a pre-configured rule, and the UE can efficiently receive CRAT_DCI from the base station. That is, for example, the UE may not perform unnecessary operations such as blind decoding of CRAT_DCI.

FIG. 15 shows operations of the first device based on an embodiment of the present disclosure.

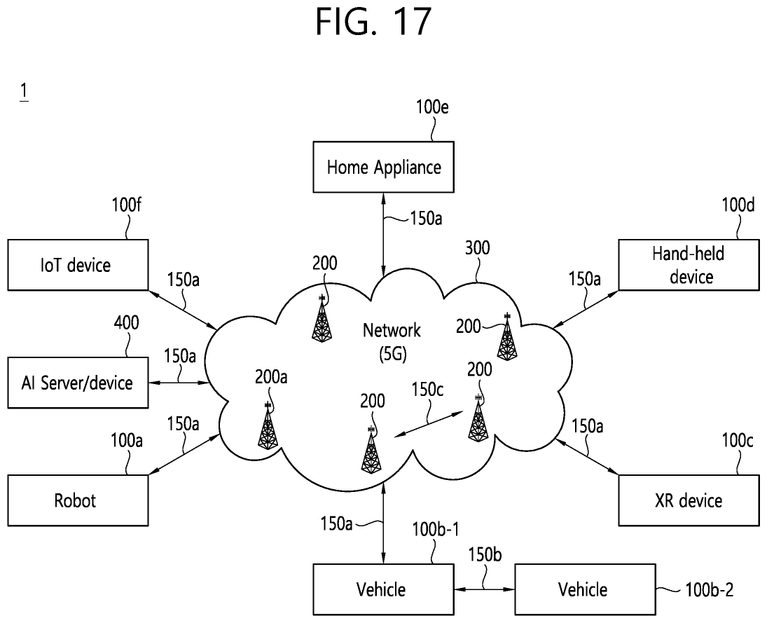

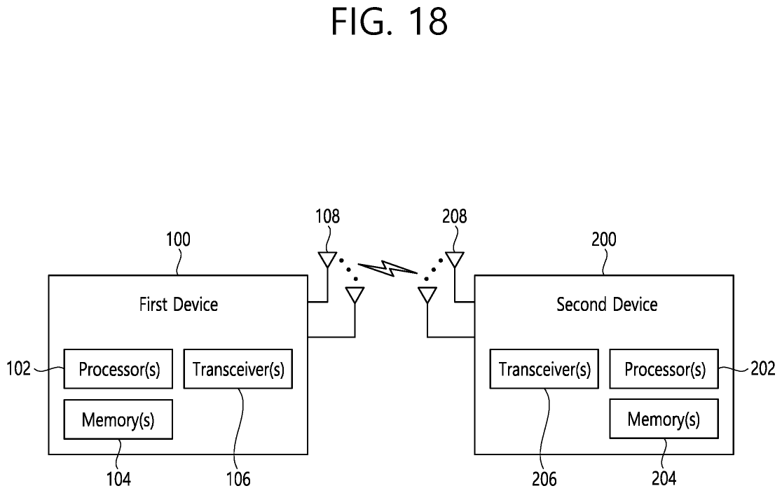

Operations disclosed in the flowchart of FIG. 15 may be performed in combination with various embodiments of the present disclosure. In an example, the operations disclosed in the flowchart of FIG. 15 may be performed based on at least one of the device(s) shown in FIGS. 17 to 22. In an example, the first device of FIG. 15 may correspond to the first wireless device 100 of FIG. 18 to be described later. In another example, the first device of FIG. 15 may correspond to the second wireless device 200 of FIG. 18 to be described later.

In step S1510, the first device according to an embodiment may receive, from a new radio (NR) base station through a physical downlink control channel (PDCCH), first downlink control information (DCI) including information regarding a resource for long-term evolution (LTE) sidelink communication of the first device.

In an example, the first DCI may correspond to CRAT_DCI described above with reference to FIGS. 13 and 14. The first DCI may be otherwise referred to as DCI 3_1, DCI FORMAT 3_1, cross-RAT DCI, or NR DCI. For example, the first DCI or the cross-RAT DCI may refer to DCI transmitted by the NR base station to control LTE sidelink communication of the first device performing wireless communication based on an NR module and an LTE module. For example, the first DCI or the cross-RAT DCI may be processed in the NR module of the first device and transferred to the LTE module, and the LTE module of the first device may perform LTE sidelink communication based on information included in the first DCI received from the NR base station.

In step S1520, the first device according to an embodiment may transmit, to a second device through a physical sidelink control channel (PSCCH), sidelink control information (SCI) based on the resource.

In step S1530, the first device according to an embodiment may transmit data to the second device through a physical sidelink shared channel (PSSCH) related to the PSCCH.

In an example, based on a first DCI size obtained based on at least one second DCI different from the first DCI, a size of the first DCI may be aligned by the NR base station from a second DCI size to the first DCI size.

In an example, the first DCI size may correspond to information related to NR Uu DCI described above with reference to FIG. 14. For example, the at least one second DCI different from the first DCI may correspond to the NR Uu DCI. For example, the size of all or part of the NR Uu DCI may be greater than the second DCI size of the first DCI.

In an example, based on no DCI for NR sidelink mode 1, the size of the first DCI may be aligned by the NR base station from the second DCI size to the first DCI size.

In an example, DCI for the NR sidelink mode 1 may correspond to NR SL MODE 1 DCI described above in FIGS. 13 and 14. The DCI for the NR sidelink mode 1 may be differently referred to as DCI 3_0, DCI FORMAT 3_0, and the like.

In an example, a size of each of the at least one second DCI may be greater than or equal to the size of the first DCI.

In an example, the first DCI size may be a smallest among at least one DCI size of the at least one second DCI.

In an example, the first DCI size may have a smallest difference from the second DCI size among at least one DCI size of the at least one second DCI.

In an example, the size of the first DCI may be aligned by the NR base station from the second DCI size to the first DCI size, by performing zero padding by a difference in a number of bits between the second DCI size and the first DCI size.

In an example, based on that a DCI format budget related to the at least one second DCI and the first DCI is exceeded when the second DCI size is not adjusted to the first DCI size, the size of the first DCI may be aligned by the NR base station from the second DCI size to the first DCI size.

In an embodiment, the DCI format or the blind decoding budget may relate to Table 6 below.

```
TABLE 6
Agreements:
  • If the DCI size budget is not exceeded, no alignment of DCI format 3_0 / 3_1 with other
NR DCI formats is performed.
  • If the DCI size budget is exceeded, DCI format 3_0 / 3_1 is zero-padded until the size is
equal to that of the next large Uu DCI format (in size)
  • The UE does not expect that the following two conditions happen simultaneously:
    □ The DCI size budget is exhausted
    □ DCI format 3_0 / 3_1 is larger than all other configured DCI formats.
  • Note: the DCI size budget is performed for Uu DCI formats first, before the
considerations for DCI format 3_0 / 3_1 as listed in the above bullets
```

For example, whether the DCI format budget or the blind decoding budget (or Uu DCI budget) is exceeded may be decided (or determined) by performing additional calculation considering the first DCI after a calculation considering the Uu DCI format is performed preferentially. If the DCI format budget or the blind decoding budget (or Uu DCI budget) is exceeded, size fitting for the first DCI may be performed.

In an embodiment, the first DCI size may be pre-configured by a DCI format of one DCI among the at least one second DCI.

In an embodiment, based on at least one of a chain-based resource reservation operation, a retransmission operation, a configured grant-based resource selection operation, a resource pool, a service type, a service priority, a cast type, a destination ID, a source ID, a quality of service (QoS) parameter, a congestion level, a mode type, a packet size, or a number of subchannels used for physical sidelink shared channel (PSSCH) transmission, the size of the first DCI may be aligned by the NR base station from the second DCI size to the first DCI size.

In an embodiment, the at least one second DCI may be an NR UU DCI. The at least one second DCI may be fallback DCI transmitted on a UE-specific search space. Or, the at least one second DCI may be non-fallback DCI transmitted on a UE-specific search space. Or, the at least one second DCI may be C-RNTI-based fallback DCI or C-RNTI-based non-fallback DCI transmitted on a UE-specific search space. Information related to the at least one second DCI may be pre-configured.

In an example, a value of the first DCI size used for size fitting of the first DCI may be limited to always greater than or equal to the second DCI size.

The first device according to an embodiment may perform monitoring of the first DCI (e.g., DCI format 3_1) based on the first DCI (monitoring) size obtained based on the at least one second DCI, based on that the blind decoding (BD) budget (or DCI format budget) for the first DCI (e.g., DCI format 3_1, cross-RAT DCI, DCI 3_1, etc.) and at least one different second DCI (e.g., at least one of NR Uu DCI (more specifically, e.g., DCI format 0_0, DCI format 0_1, DCI format 0_2, DCI format 1_0, DCI format 1_1, DCI format 1_2, DCI format 2_0, DCI format 2_1, DCI format 2_2, DCI format 2_3, DCI format 2_4, DCI format 2_5, DCI format 2_6, etc.) is exceeded.

In an embodiment, the DCI (monitoring) size for monitoring the first DCI may be aligned by the NR base station from the second DCI (monitoring) size to the first DCI (monitoring) size.

In an embodiment, the DCI (monitoring) size for each of the at least one second DCI may be greater than or equal to the second DCI (monitoring) size.

In an embodiment, the first DCI (monitoring) size may be the smallest of at least one DCI (monitoring) size of the at least one second DCI.

In an embodiment, the first DCI (monitoring) size may have a smallest difference from the second DCI (monitoring) size among at least one DCI (monitoring) size of the at least one second DCI.

In an embodiment, the DCI (monitoring) size of the first DCI may be aligned from the second DCI (monitoring) size to the first DCI (monitoring) size by the NR base station, by performing zero padding by a difference in a number of bits between the first DCI (monitoring) size and the second DCI (monitoring) size.

In an embodiment, a monitoring domain/resource/bit based on the aligned DCI (monitoring) size for monitoring the first DCI may include a zero-padded domain/resource/bit.

The first device according to an embodiment may perform monitoring of the first DCI (e.g., DCI format 3_1) based on the first DCI size obtained based on the at least one second DCI, based on that the blind decoding (BD) budget (or DCI format budget) for the first DCI (e.g., DCI format 3_1, cross-RAT DCI, DCI 3_1, etc.) and at least one different second DCI (e.g., at least one of NR Uu DCI (more specifically, e.g., DCI format 0_0, DCI format 0_1, DCI format 0_2, DCI format 1_0, DCI format 1_1, DCI format 1_2, DCI format 2_0, DCI format 2_1, DCI format 2_2, DCI format 2_3, DCI format 2_4, DCI format 2_5, DCI format 2_6, etc.) is exceeded.

In an embodiment, the DCI size for monitoring the first DCI may be aligned by the NR base station from the second DCI size to the first DCI size.

In an embodiment, the DCI size for each of the at least one second DCI may be greater than or equal to the second DCI size.

In an embodiment, the first DCI size may be the smallest among at least one DCI size of the at least one second DCI.

In an embodiment, the first DCI size may have a minimum difference from the second DCI size among at least one DCI size of the at least one second DCI.

In an embodiment, the DCI size of the first DCI may be aligned by the NR base station from the second DCI size to the first DCI size, by performing zero padding by the difference in the number of bits between the first DCI size and the second DCI size.

In an embodiment, a monitoring domain/resource/bit for monitoring the first DCI based on the aligned DCI size may include a zero-padded domain/resource/bit.

In an embodiment, based on that the DCI format budget related to the at least one second DCI and the first DCI is exceeded, the first device may expect that the NR base station does not configure all of at least one DCI size of the at least one second DCI to be smaller than the second DCI size of the first DCI.

Based on an embodiment of the present disclosure, a first device adapted to perform sidelink communication may be provided. For example, the first device may comprise: at least one memory storing instructions; at least one transceiver; and at least one processor connected to the at least one memory and the at least one transceiver. For example, the at least one processor may execute the instructions to: control the at least one transceiver to receive, from a new radio (NR) base station through a physical downlink control channel (PDCCH), first downlink control information (DCI) including information regarding a resource for long-term evolution (LTE) sidelink communication of the first device; control the at least one transceiver to transmit, to a second device through a physical sidelink control channel (PSCCH), sidelink control information (SCI) based on the resource; and control the at least one transceiver to transmit data to the second device through a physical sidelink shared channel (PSSCH) related to the PSCCH. Based on a first DCI size obtained based on at least one second DCI different from the first DCI, a size of the first DCI may be aligned by the NR base station from a second DCI size to the first DCI size.

Based on an embodiment of the present disclosure, an apparatus (or chip (set)) adapted to control a first user equipment (UE) may be provided. For example, the apparatus may comprise: at least one processor; and at least one memory connected to the at least one processor and storing instructions. For example, the at least one processor may execute the instructions to: receive, from a new radio (NR) base station through a physical downlink control channel (PDCCH), first downlink control information (DCI) including information regarding a resource for long-term evolution (LTE) sidelink communication of the first UE; transmit, to a second UE through a physical sidelink control channel (PSCCH), sidelink control information (SCI) based on the resource; and transmit data to the second UE through a physical sidelink shared channel (PSSCH) related to the PSCCH. Based on a first DCI size obtained based on at least one second DCI different from the first DCI, a size of the first DCI may be aligned by the NR base station from a second DCI size to the first DCI size.

In an example, the first UE in the above embodiment may represent the first device described in the present disclosure. In an example, in the case of the at least one processor, the at least one memory, etc. in the apparatus adapted to control the first UE, each may be implemented as a separate sub chip, or at least two or more components may be implemented through one sub chip.

Based on an embodiment of the present disclosure, a non-transitory computer-readable storage medium storing instructions (or commands) may be provided. The non-transitory computer-readable storage medium, when executed the instructions, may cause a first device to: receive, from a new radio (NR) base station through a physical downlink control channel (PDCCH), first downlink control information (DCI) including information regarding a resource for long-term evolution (LTE) sidelink communication of the first device; transmit, to a second device through a physical sidelink control channel (PSCCH), sidelink control information (SCI) based on the resource; and transmit data to the second device through a physical sidelink shared channel (PSSCH) related to the PSCCH. Based on a first DCI size obtained based on at least one second DCI different from the first DCI, a size of the first DCI may be aligned by the NR base station from a second DCI size to the first DCI size.

FIG. 16 shows operations of the NR base station based on an embodiment of the present disclosure.

Operations disclosed in the flowchart of FIG. 16 may be performed in combination with various embodiments of the present disclosure. In an example, the operations disclosed in the flowchart of FIG. 16 may be performed based on at least one of the device(s) shown in FIGS. 17 to 22. In an example, the NR base station of FIG. 16 may correspond to the second wireless device 200 of FIG. 18 described later. In another example, the NR base station of FIG. 16 may correspond to the first wireless device 100 of FIG. 18 described later.

In step S1610, the NR base station according to an embodiment may align a size of first DCI from a second DCI size to a first DCI size, based on the first DCI size obtained based on at least one second DCI different from the first DCI including information regarding a resource for LTE sidelink communication of a first device.

In an example, the first DCI size may correspond to information related to NR Uu DCI described above with reference to FIG. 14. For example, the at least one second DCI different from the first DCI may correspond to the NR Uu DCI. For example, the size of all or part of the NR Uu DCI may be greater than the second DCI size of the first DCI.

In step S1620, the NR base station according to an embodiment may transmit the first DCI to the first device through a PDCCH.

In an example, the first DCI may correspond to CRAT_DCI described above with reference to FIGS. 13 and 14. The first DCI may be otherwise referred to as DCI 3_1, DCI FORMAT 3_1, cross-RAT DCI, or NR DCI. For example, the first DCI or the cross-RAT DCI may refer to DCI transmitted by the NR base station to control LTE sidelink communication of the first device performing wireless communication based on an NR module and an LTE module. For example, the first DCI or the cross-RAT DCI may be processed in the NR module of the first device and transferred to the LTE module, and the LTE module of the first device may perform LTE sidelink communication based on information included in the first DCI received from the NR base station.

In an example, aligning the size of the first DCI may comprise: aligning the size of the first DCI from the second DCI size to the first DCI size, based on no DCI for NR sidelink mode 1.

In an example, based on no DCI for NR sidelink mode 1, the size of the first DCI may be aligned by the NR base station from the second DCI size to the first DCI size.

In an example, a size of each of the at least one second DCI may be greater than or equal to the size of the first DCI.

In an example, the first DCI size may be a smallest among at least one DCI size of the at least one second DCI.

In an example, the first DCI size may have a smallest difference from the second DCI size among at least one DCI size of the at least one second DCI.

In an example, the size of the first DCI may be aligned by the NR base station from the second DCI size to the first DCI size, by performing zero padding by a difference in a number of bits between the second DCI size and the first DCI size.

In an example, based on that a DCI format budget related to the at least one second DCI and the first DCI is exceeded when the second DCI size is not adjusted to the first DCI size, the size of the first DCI may be aligned by the NR base station from the second DCI size to the first DCI size.

In an embodiment, the DCI format or the blind decoding budget may relate to Table 7 below.

```
TABLE 7
Agreements:
  • If the DCI size budget is not exceeded, no alignment of DCI format 3_0 / 3_1 with other
NR DCI formats is performed.
  • If the DCI size budget is exceeded, DCI format 3_0 / 3_1 is zero-padded until the size is
equal to that of the next large Uu DCI format (in size)
  • The UE does not expect that the following two conditions happen simultaneously:
    □ The DCI size budget is exhausted
    □ DCI format 3_0 / 3_1 is larger than all other configured DCI formats.
  • Note: the DCI size budget is performed for Uu DCI formats first, before the
considerations for DCI format 3_0 / 3_1 as listed in the above bullets
```

For example, whether the DCI format budget or the blind decoding budget (or Uu DCI budget) is exceeded may be decided (or determined) by performing additional calculation considering the first DCI after a calculation considering the Uu DCI format is performed preferentially. If the DCI format budget or the blind decoding budget (or Uu DCI budget) is exceeded, size fitting for the first DCI may be performed.

In an embodiment, the first DCI size may be pre-configured by a DCI format of one DCI among the at least one second DCI.

In an embodiment, based on at least one of a chain-based resource reservation operation, a retransmission operation, a configured grant-based resource selection operation, a resource pool, a service type, a service priority, a cast type, a destination ID, a source ID, a quality of service (QoS) parameter, a congestion level, a mode type, a packet size, or a number of subchannels used for physical sidelink shared channel (PSSCH) transmission, the size of the first DCI may be aligned by the NR base station from the second DCI size to the first DCI size.

In an embodiment, the at least one second DCI may be an NR UU DCI. The at least one second DCI may be fallback DCI transmitted on a UE-specific search space. Or, the at least one second DCI may be non-fallback DCI transmitted on a UE-specific search space. Or, the at least one second DCI may be C-RNTI-based fallback DCI or C-RNTI-based non-fallback DCI transmitted on a UE-specific search space. Information related to the at least one second DCI may be pre-configured.

In an example, a value of the first DCI size used for size fitting of the first DCI may be limited to always greater than or equal to the second DCI size.

The first device according to an embodiment may perform monitoring of the first DCI (e.g., DCI format 3_1) based on the first DCI (monitoring) size obtained based on the at least one second DCI, based on that the blind decoding (BD) budget (or DCI format budget) for the first DCI (e.g., DCI format 3_1, cross-RAT DCI, DCI 3_1, etc.) and at least one different second DCI (e.g., at least one of NR Uu DCI (more specifically, e.g., DCI format 0_0, DCI format 0_1, DCI format 0_2, DCI format 1_0, DCI format 1_1, DCI format 1_2, DCI format 2_0, DCI format 2_1, DCI format 2_2, DCI format 2_3, DCI format 2_4, DCI format 2_5, DCI format 2_6, etc.) is exceeded.

In an embodiment, the DCI (monitoring) size for monitoring the first DCI may be aligned by the NR base station from the second DCI (monitoring) size to the first DCI (monitoring) size.

In an embodiment, the DCI (monitoring) size for each of the at least one second DCI may be greater than or equal to the second DCI (monitoring) size.

In an embodiment, the first DCI (monitoring) size may be the smallest of at least one DCI (monitoring) size of the at least one second DCI.

In an embodiment, the first DCI (monitoring) size may have a smallest difference from the second DCI (monitoring) size among at least one DCI (monitoring) size of the at least one second DCI.

In an embodiment, the DCI (monitoring) size of the first DCI may be aligned from the second DCI (monitoring) size to the first DCI (monitoring) size by the NR base station, by performing zero padding by a difference in a number of bits between the first DCI (monitoring) size and the second DCI (monitoring) size.

In an embodiment, a monitoring domain/resource/bit based on the aligned DCI (monitoring) size for monitoring the first DCI may include a zero-padded domain/resource/bit.

The first device according to an embodiment may perform monitoring of the first DCI (e.g., DCI format 3_1) based on the first DCI size obtained based on the at least one second DCI, based on that the blind decoding (BD) budget (or DCI format budget) for the first DCI (e.g., DCI format 3_1, cross-RAT DCI, DCI 3_1, etc.) and at least one different second DCI (e.g., at least one of NR Uu DCI (more specifically, e.g., DCI format 0_0, DCI format 0_1, DCI format 0_2, DCI format 1_0, DCI format 1_1, DCI format 1_2, DCI format 2_0, DCI format 2_1, DCI format 2_2, DCI format 2_3, DCI format 2_4, DCI format 2_5, DCI format 2_6, etc.) is exceeded.

In an embodiment, the DCI size for monitoring the first DCI may be aligned by the NR base station from the second DCI size to the first DCI size.

In an embodiment, the DCI size for each of the at least one second DCI may be greater than or equal to the second DCI size.

In an embodiment, the first DCI size may be the smallest among at least one DCI size of the at least one second DCI.

In an embodiment, the first DCI size may have a minimum difference from the second DCI size among at least one DCI size of the at least one second DCI.

In an embodiment, the DCI size of the first DCI may be aligned by the NR base station from the second DCI size to the first DCI size, by performing zero padding by the difference in the number of bits between the first DCI size and the second DCI size.

In an embodiment, a monitoring domain/resource/bit for monitoring the first DCI based on the aligned DCI size may include a zero-padded domain/resource/bit.

In an embodiment, based on that the DCI format budget related to the at least one second DCI and the first DCI is exceeded, the first device may expect that the NR base station does not configure all of at least one DCI size of the at least one second DCI to be smaller than the second DCI size of the first DCI.

Based on an embodiment of the present disclosure, an NR base station adapted to perform wireless communication may be provided. For example, the base station may comprise: at least one memory storing instructions; at least one transceiver; and at least one processor connected to the at least one memory and the at least one transceiver. For example, the at least one processor may execute the instructions to: align a size of first DCI from a second DCI size to a first DCI size, based on the first DCI size obtained based on at least one second DCI different from the first DCI including information regarding a resource for LTE sidelink communication of a first device; and control the at least one transceiver to transmit the first DCI to the first device through a PDCCH.

Various embodiments of the present disclosure may be independently implemented. Alternatively, the various embodiments of the present disclosure may be implemented by being combined or merged. For example, although the various embodiments of the present disclosure have been described based on the 3GPP LTE system for convenience of explanation, the various embodiments of the present disclosure may also be extendedly applied to another system other than the 3GPP LTE system. For example, the various embodiments of the present disclosure may also be used in an uplink or downlink case without being limited only to direct communication between UEs. In this case, a base station, a relay node, or the like may use the proposed method according to various embodiments of the present disclosure. For example, it may be defined that information on whether to apply the method according to various embodiments of the present disclosure is reported by the base station to the UE or by a transmitting UE to a receiving UE through pre-defined signaling (e.g., physical layer signaling or higher layer signaling). For example, it may be defined that information on a rule according to various embodiments of the present disclosure is reported by the base station to the UE or by a transmitting UE to a receiving UE through pre-defined signaling (e.g., physical layer signaling or higher layer signaling). For example, some embodiments among various embodiments of the present disclosure may be applied limitedly only to a resource allocation mode 1. For example, some embodiments among various embodiments of the present disclosure may be applied limitedly only to a resource allocation mode 2.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 17 shows a communication system 1, based on an embodiment of the present disclosure.

Referring to FIG. 17, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Herein, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 18 shows wireless devices, based on an embodiment of the present disclosure.

Referring to FIG. 18, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 17.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

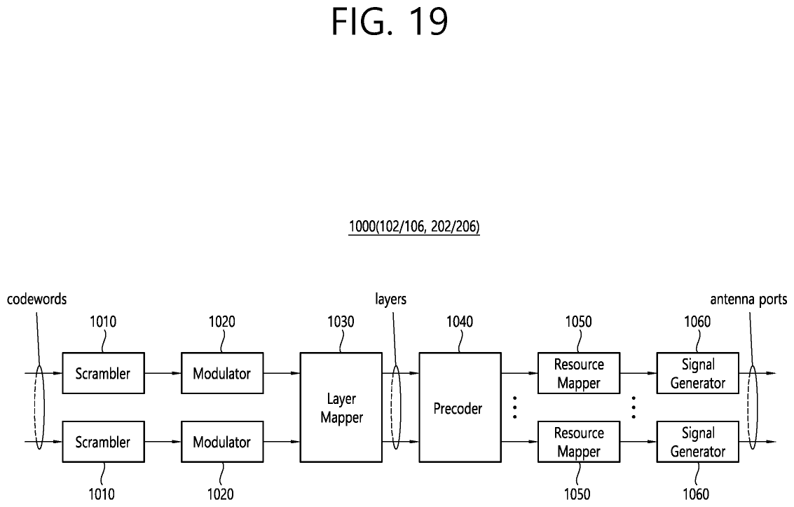

FIG. 19 shows a signal process circuit for a transmission signal, based on an embodiment of the present disclosure.

Referring to FIG. 19, a signal processing circuit 1000 may include scramblers 1010, modulators 1020, a layer mapper 1030, a precoder 1040, resource mappers 1050, and signal generators 1060. An operation/function of FIG. 19 may be performed, without being limited to, the processors 102 and 202 and/or the transceivers 106 and 206 of FIG. 18. Hardware elements of FIG. 19 may be implemented by the processors 102 and 202 and/or the transceivers 106 and 206 of FIG. 18. For example, blocks 1010 to 1060 may be implemented by the processors 102 and 202 of FIG. 18. Alternatively, the blocks 1010 to 1050 may be implemented by the processors 102 and 202 of FIG. 18 and the block 1060 may be implemented by the transceivers 106 and 206 of FIG. 18.

Codewords may be converted into radio signals via the signal processing circuit 1000 of FIG. 19. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 19. For example, the wireless devices (e.g., 100 and 200 of FIG. 18) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

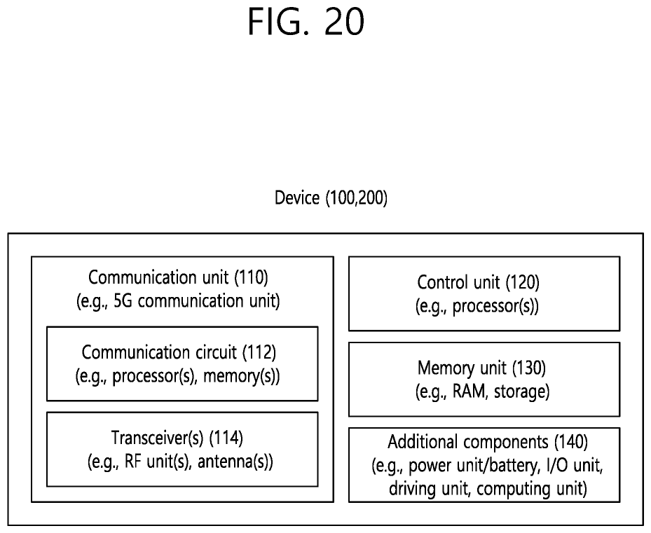

FIG. 20 shows another example of a wireless device, based on an embodiment of the present disclosure. The wireless device may be implemented in various forms according to a use-case/service (refer to FIG. 17).

Referring to FIG. 20, wireless devices 100 and 200 may correspond to the wireless devices 100 and 200 of FIG. 18 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 18. For example, the transceiver(s) 114 may include the one or more transceivers 106 and 206 and/or the one or more antennas 108 and 208 of FIG. 18. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 17), the vehicles (100b-1 and 100b-2 of FIG. 17), the XR device (100c of FIG. 17), the hand-held device (100d of FIG. 17), the home appliance (100e of FIG. 17), the IoT device (100f of FIG. 17), a digital broadcast terminal, a hologram device, a public safety device, an MTC device, a medicine device, a fintech device (or a finance device), a security device, a climate/environment device, the AI server/device (400 of FIG. 17), the BSs (200 of FIG. 17), a network node, etc. The wireless device may be used in a mobile or fixed place according to a use-example/service.

In FIG. 20, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 20 will be described in detail with reference to the drawings.

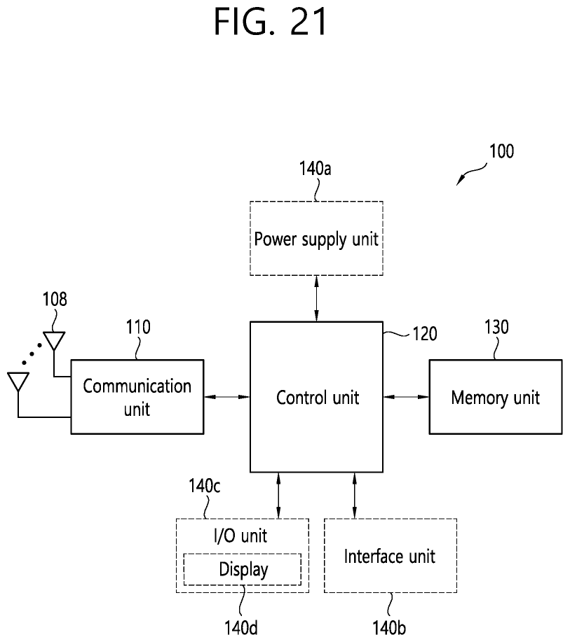

FIG. 21 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 21, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 20, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

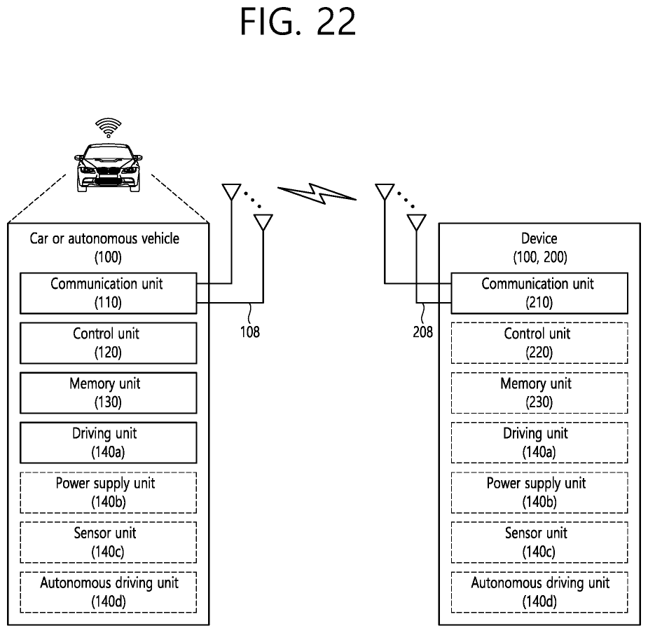

FIG. 22 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc.

Referring to FIG. 22, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 20, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

The scope of the disclosure may be represented by the following claims, and it should be construed that all changes or modifications derived from the meaning and scope of the claims and their equivalents may be included in the scope of the disclosure.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1-20. (canceled)

21. A method for performing wireless communication by a first device, the method comprising:
monitoring first control information formats for downlink (DL) communication or uplink (UL) communication; and
monitoring a second control information format for scheduling long-term evolution (LTE) sidelink (SL) communication,
wherein, based on that (i) the first device is not configured to monitor a third control information format for scheduling NR SL communication and (ii) a total number of sizes of the first control information formats and a second control information format before performing size alignment is greater than a threshold, a size of the second control information format equals, by zero padding, a smallest size among sizes of the first control information formats that is larger than a size of the second control information format before performing size alignment, and
wherein the size of the second control information format before performing size alignment is smaller than or equal to a largest size among all sizes of the first control information formats.

22. The method of claim 21, wherein it is not allowed that the size of the second control information format before performing size alignment is larger than the largest size among all sizes of the first control information formats.

23. The method of claim 21, wherein a size of a third control information format before performing size alignment is smaller than or equal to a largest size among all sizes of the first control information formats.

24. The method of claim 23, wherein it is not allowed that the size of the third control information format before performing size alignment is larger than the largest size among all sizes of the first control information formats.

25. The method of claim 21, wherein the second control information format includes information for activating or release an LTE SL Semi-Persistent Scheduling (SPS) configuration.

26. The method of claim 21, wherein the second control information format is transmitted by an NR base station.

27. The method of claim 21, wherein, based on that the first device is configured to monitor the third control information format, the size of the second control information format equals a size of the third control information format.

28. The method of claim 27, wherein, based on that (i) the first device is configured to monitor the third control information format and (ii) the size of the second control information format before performing size alignment is smaller than a size of a third control information format before performing size alignment, the size of the second control information format is aligned with the size of the third control information format by zero padding.

29. The method of claim 27, wherein, based on that (i) the first device is configured to monitor the third control information format and (ii) a size of a third control information format before performing size alignment is smaller than the size of the second control information format before performing size alignment, the size of the third control information format is aligned with the size of the second control information format by zero padding.

30. A first device adapted to perform wireless communication, the first device comprising:
at least one memory storing instructions;
at least one transceiver; and
at least one processor connected to the at least one memory and the at least one transceiver, wherein the at least one processor executes the instructions to:
monitor first control information formats for downlink (DL) communication or uplink (UL) communication; and
monitor a second control information format for scheduling long-term evolution (LTE) sidelink (SL) communication,
wherein, based on that (i) the first device is not configured to monitor a third control information format for scheduling NR SL communication and (ii) a total number of sizes of the first control information formats and a second control information format before performing size alignment is greater than a threshold, a size of the second control information format equals, by zero padding, a smallest size among sizes of the first control information formats that is larger than a size of the second control information format before performing size alignment, and
wherein the size of the second control information format before performing size alignment is smaller than or equal to a largest size among all sizes of the first control information formats.

31. The first device of claim 30, wherein it is not allowed that the size of the second control information format before performing size alignment is larger than the largest size among all sizes of the first control information formats.

32. The first device of claim 30, wherein, based on that the first device is configured to monitor the third control information format, the size of the second control information format equals a size of the third control information format.

33. A method for performing wireless communication by a base station, the method comprising:
transmitting first control information formats for downlink (DL) communication or uplink (UL) communication; and
transmitting a second control information format for scheduling long-term evolution (LTE) sidelink (SL) communication,
wherein, based on that (i) monitoring of a third control information format for scheduling NR SL communication is not configured and (ii) a total number of sizes of the first control information formats and a second control information format before performing size alignment is greater than a threshold, a size of the second control information format is aligned, by zero padding, with a smallest size among sizes of the first control information formats that is larger than a size of the second control information format before performing size alignment, and
wherein the size of the second control information format before performing size alignment is smaller than or equal to a largest size among all sizes of the first control information formats.

34. The method of claim 33, wherein it is not allowed that the size of the second control information format before performing size alignment is larger than the largest size among all sizes of the first control information formats.

35. The method of claim 33, wherein a size of a third control information format before performing size alignment is smaller than or equal to a largest size among all sizes of the first control information formats, and
wherein it is not allowed that the size of the third control information format before performing size alignment is larger than the largest size among all sizes of the first control information formats.

36. The method of claim 33, wherein the second control information format includes information for activating or release an LTE SL Semi-Persistent Scheduling (SPS) configuration.

37. The method of claim 33, wherein the second control information format is transmitted by an NR base station.

38. The method of claim 33, wherein, based on that monitoring of the third control information format is configured, the size of the second control information format equals a size of the third control information format.

39. The method of claim 38, wherein, based on that (i) monitoring of the third control information format is configured and (ii) the size of the second control information format before performing size alignment is smaller than a size of a third control information format before performing size alignment, the size of the second control information format is aligned with the size of the third control information format by zero padding.

40. The method of claim 38, wherein, based on that (i) monitoring of the third control information format is configured and (ii) a size of a third control information format before performing size alignment is smaller than the size of the second control information format before performing size alignment, the size of the third control information format is aligned with the size of the second control information format by zero padding.
